(19) United States
(12) Patent Application Publication
(10) Pub. No.: US 2024/0042874 A1
(43) Pub. Date: Feb. 8, 2024

(54) HYBRID ELECTRIC AND HYDROGEN DISPENSING SYSTEMS AND METHODS

(71) Applicant: Ivys Inc., Waltham, MA (US)

(72) Inventors: Darryl Edward Pollica, Melrose, MA (US); Christopher John O'Brien, Somerville, MA (US); Bryan Gordon, Goffstown, NH (US); Prabhu K. Rao, Newton, MA (US); Paul Gaffuri, Waltham, MA (US)

(73) Assignee: Ivys Inc., Waltham, MA (US)

(21) Appl. No.: 18/348,764

(22) Filed: Jul. 7, 2023

Related U.S. Application Data
(60) Provisional application No. 63/458,049, filed on Apr. 7, 2023.
(60) Provisional application No. 63/358,928, filed on Jul. 7, 2022.

(51) Int. Cl. B60L 53/16; F17C 5/06; B60L 53/18; B60L 53/10; B60L 53/122; B60L 53/63; B60L 53/64; B60L 55/00

(52) U.S. Cl. CPC B60L 53/16; F17C 5/06; B60L 53/18; B60L 53/11; B60L 53/122; B60L 53/63; B60L 53/64; B60L 55/00; F17C 2221/012; F17C 2270/0139; B60L 2210/30; B60L 2210/44

(57) ABSTRACT

According to at least one aspect, a hybrid dispenser comprising at least one hydrogen gas nozzle configured to dispense hydrogen gas to a fuel tank of a vehicle is provided. According to some aspects, the hybrid dispenser comprises one or more electrical connectors for connecting to a vehicle to exchange electrical power, and at least one controller configured to cause electrical power to be provided to a vehicle via at least one of the one or more electrical connectors in a first operating mode and cause electrical power to be received from a vehicle via at least one of the one or more electrical connectors in a second operating mode. According to some aspect, the hybrid dispenser comprising a wireless charging system and at least one controller configured to initiate operation of the wireless charging system to wirelessly charge the vehicle during a charging event.

### CROSS REFERENCE TO RELATED APPLICATIONS

This application claims priority under 35 U.S.C. § 119 to U.S. Provisional Application Ser. No. 63/458,049, filed Apr. 7, 2023, and titled WIRELESS CHARGING SYSTEMS AND METHODS and to U.S. Provisional Application Ser. No. 63/358,928, filed Jul. 7, 2022 and titled HYBRID ELECTRIC AND HYDROGEN FUELING SYSTEMS AND METHODS, each application of which is herein incorporated by reference in its entirety

### BACKGROUND

Electric vehicles (EVs) are emerging as a zero-emission alternative to internal combustion engine vehicles. Electric vehicles include both battery electric vehicles (BEVs) and hydrogen fuel cell vehicles (HFCV), also referred to herein as fuel cell electric vehicles (FCEVs). BEVs operate with a large battery that provides electricity to drive an electric motor. This battery needs to be periodically recharged to operate the vehicle. FIGS. 1A-1C illustrate typical ways in which BEVs are charged. FIG. 1A illustrates an example of Level 1 charging of BEV 100b using a charging cable 28 having a plug 26 configured for a standard wall outlet on one end and a connector 27 configured to mate with a reciprocal connector provided on electrical port 117 of BEV 100b. Level 1 charging allows a BEV to be charged using standard household AC power (e.g., 120 VAC) via a standard wall outlet, but at very slow rates. BEVs are frequently sold with a corresponding Level 1 charging cable.

FIG. 1B illustrates an example of Level 2 charging in which a charging unit 4 delivers higher levels of AC power (e.g., 240 VAC) for faster charging rates, but requires special equipment that typically must be professionally installed for home use, unless a large appliance outlet is available and a corresponding Level 2 charging cable is obtained (e.g., a cable with a plug on one end adapted for a large appliance outlet). FIG. 1C illustrates an example of fast DC charging in which a charging station 103 delivers DC power to BEV 100b via electrical cable 18 and connector 27. Conventionally, DC power provided by charging station 103 is converted from three-phase AC power delivered by the utility grid to provide the high-current DC power needed for fast DC charging and is therefore not available for home use. Because the distance a BEV can travel before needing to be recharged depends on the electrical storage capacity of the battery, BEV batteries are typically relatively large, heavy and expensive.

FCEVs operate by providing compressed hydrogen to a fuel cell system (e.g., a fuel cell stack) that converts hydrogen gas into electricity to drive an electric motor. Similar to internal combustion engine vehicles, FCEVs are equipped with fuel tanks that must be refilled periodically, but with hydrogen gas rather than petroleum-based fuel (e.g., gasoline, diesel or the like). As illustrated in FIG. 1D, conventional refueling of an FCEV 100a involves engaging the fuel tank of the FCEV with a nozzle 125 configured to dispense hydrogen gas to the fuel tank of the vehicle under the control of hydrogen gas dispenser 102. Hydrogen gas from the fuel tank is converted to electrical power by fuel cell system 145 to power the vehicle's electric motor and other electronic components of the vehicle. Conventional FCEV's typically also include a battery 113 that is charged via electrical power produced by fuel cell system 145. Battery power may also be used to drive the motor (e.g., for additional fast-response, peak power, etc.). However, because the distance an FCEV can travel before requiring refueling depends on the energy stored in the hydrogen gas in the fuel tank and not the capacity of the battery, FCEV batteries are typically small, lightweight and inexpensive compared to BEV batteries.

Another type of EV is a hybrid vehicle that utilizes aspects of both FCEVs and BEVs and can be refueled with hydrogen gas like an FCEV and can be charged like a BEV. This hybrid EV is referred to herein as a plug-in fuel cell electric vehicle (PFCEV). An example PFCEV 100c is illustrated in FIG. 1E. A distinction between FCEV 100a illustrated in FIG. 1D and PFCEV 100c illustrated in FIG. 1E is that PFCEV 100c includes electrical port 117 having a connector to which a charging cable can be connected to charge battery 213 (e.g., using the conventional BEV charging methods illustrated in FIGS. 1A-1C). Battery 213 can be used to extend the distance PFCEV 100c can travel before requiring refueling and/or recharging and, as such, is typically larger than an FCEV battery and is designed and configured to power the electric motor (and other power systems of the vehicle) for extended durations. The storage capacity of battery 213 may be chosen as a matter of design preference (including batteries having the storage capacity of state-of-the-art BEVs) in consideration of cost, footprint, weight, whether battery 213 is designed as the primary or secondary power source and/or other considerations involving hybrid control techniques that utilize electrical power provided by fuel cell system 145 and electrical power provided by battery 213 to operate the vehicle.

### SUMMARY

Some embodiments include a hybrid dispenser comprising at least one hydrogen gas nozzle configured to dispense hydrogen gas to a fuel tank of a vehicle, one or more electrical connectors for connecting to a vehicle to exchange electrical power, and at least one controller configured to cause hydrogen gas to be dispensed to a vehicle via the at least one hydrogen gas nozzle during a fueling event, cause electrical power to be provided to a vehicle via at least one of the one or more electrical connectors in a first operating mode, and cause electrical power to be received from a vehicle via at least one of the one or more electrical connectors in a second operating mode.

Some embodiments include a method of utilizing a vehicle as an electrical power generator, the method comprising dispensing hydrogen gas to a fuel cell system of the vehicle, wherein the fuel cell system converts the hydrogen gas to electrical power, at least some of which is provided to a battery of the vehicle, establishing at least one electrical connection to the vehicle, receiving electrical power from the vehicle via the at least one electrical connection, and providing at least some of the electrical power from the vehicle to one or more electrical power receivers.

Some embodiments include a hybrid dispenser comprising at least one hydrogen gas nozzle configured to dispense hydrogen gas to a fuel tank of a vehicle, a wireless charging system, and at least one controller configured to cause hydrogen gas to be dispensed to a vehicle via the at least one hydrogen gas nozzle during a fueling event, and initiate operation of the wireless charging system to wirelessly charge the vehicle during a charging event.

Some embodiments include a system comprising at least one hydrogen gas provider configured to provide hydrogen gas to a fuel cell system, a power distribution system comprising an electrical power bus configured to distribute electrical power between electrical power providers and electrical power receivers, a plurality of power converters coupled to the electrical power bus. According to some embodiments, the plurality of power converters comprises a plurality of receive power converters configured to convert electrical power from a respective plurality of electrical power providers to provide electrical power therefrom to the electrical power bus, the plurality of receive power converters including at least one first receive power converter configured to convert electrical power from at least one electrical power network and at least one second receive power converter configured to convert electrical power from one or more electric vehicles, and a plurality of transmit power converters configured to convert electrical power from the electrical power bus to provide electrical power therefrom to a respective plurality of electrical power receivers, the plurality of transmit power converters including at least one first transmit power converter configured to provide electrical power to one or more electric vehicles. In a first operating mode according to some embodiments, the power distribution system is configured to provide, via the electrical power bus, electrical power received via the at least one first receive power converter to the at least one first transmit power converter to charge one or more electric vehicles. In a second operating mode according to some embodiments, the at least one hydrogen gas provider is configured to provide hydrogen gas to a fuel cell system of at least one electrical vehicle, and the power distribution system is configured to provide, via the electrical power bus, electrical power received via the at least one second receive power converter to one or more of the plurality of transmit power converters.

### BRIEF DESCRIPTION OF THE DRAWINGS

FIG. 1A illustrates an example Level 1 charging of a battery electric vehicle (BEV).

FIG. 1B illustrates an example Level 2 charging of a battery electric vehicle (BEV).

FIG. 1C illustrates an example fast DC charging of a battery electric vehicle (BEV).

FIG. 1D illustrates an exemplary FCEV and refueling via a hydrogen gas dispenser.

FIG. 1E illustrates an exemplary PFCEV.

FIG. 2A illustrates male and female Type 1 electrical connectors suitable for use in hybrid dispensing and/or mobile generator techniques, in accordance with some embodiments.

FIG. 2B illustrates male and female Combo 1 electrical connectors suitable for use in hybrid dispensing and/or mobile generator techniques, in accordance with some embodiments.

FIG. 2C illustrates male and female Type 2 electrical connectors suitable for use in hybrid dispensing and/or mobile generator techniques, in accordance with some embodiments.

FIG. 2D illustrates male and female Combo 2 electrical connectors suitable for use in hybrid dispensing and/or mobile generator techniques, in accordance with some embodiments.

FIG. 3A illustrates an electrical port of an electric vehicle in a first exemplary configuration suitable for use in hybrid dispensing and/or mobile generator techniques, in accordance with some embodiments.

FIG. 3B illustrates an electrical port of an electric vehicle in a second exemplary configuration suitable for use in hybrid dispensing and/or mobile generator techniques, in accordance with some embodiments.

FIG. 3C illustrates an electrical port on an electric vehicle in a third exemplary configuration suitable for use in hybrid dispensing and/or mobile generator techniques in accordance with some embodiments.

FIG. 4A illustrates an exemplary hybrid dispenser for hydrogen gas refueling and bi-directional exchange of electrical power, in accordance with some embodiments.

FIG. 4B illustrates an exemplary hybrid dispenser for hydrogen gas refueling and bi-directional exchange of electrical power, in accordance with some embodiments.

FIG. 4C illustrates an exemplary hybrid dispenser utilizing a PFCEV as an electrical power provider, in accordance with some embodiments.

FIG. 5 illustrates an exemplary method of a hybrid dispenser configured to utilize a PFCEV as a mobile generator to provide power to one or more electrical power receivers, in accordance with some embodiments.

FIG. 6 illustrates an exemplary method performed by a hybrid dispenser configured to utilize a PFCEV as a mobile generator to provide power to one or more dispensers, in accordance with some embodiments.

FIG. 7 illustrates an exemplary method performed by a hybrid dispenser configured to utilize a PFCEV as a mobile generator to provide power to electrical infrastructure, in accordance with some embodiments.

FIG. 8 illustrates an exemplary method performed by a hybrid dispenser configured to utilize a PFCEV as a mobile generator to provide power to the grid, in accordance with some embodiments.

FIG. 9 illustrates an exemplary method of using a transportable hydrogen gas supply to facilitate utilizing a PFCEV as a mobile generator to provide power to one or more electrical power receivers, in accordance with some embodiments.

FIG. 10A illustrates an exemplary hybrid dispenser comprising a hybrid dispenser controller for controlling hydrogen gas refueling and for configuring an electronics system to facilitate bi-directional exchange of electrical power, in accordance with some embodiments.

FIG. 10B illustrates an exemplary hybrid dispenser comprising a hybrid dispenser controller for controlling hydrogen gas refueling and for configuring an electronics system to facilitate bi-directional exchange of electrical power, in accordance with some embodiments.

FIG. 10C illustrates an exemplary hybrid dispenser controller for controlling hydrogen gas refueling and for configuring an electronics system to facilitate bi-directional exchange of electrical power for an exemplary hybrid dispenser, in accordance with some embodiments.

FIG. 10D illustrates an exemplary electronics system of a hybrid dispenser to facilitate bi-directional exchange of electrical power for the hybrid dispenser, in accordance with some embodiments.

FIG. 11 illustrates an exemplary hybrid dispenser comprising a hydrogen dispenser unit and an electric charging unit implemented in respective housings, in accordance with some embodiments.

FIG. 12A illustrates an exemplary power distribution system coupled to a plurality of electrical energy providers and electrical energy receivers, in accordance with some embodiments.

FIG. 12B illustrates an exemplary power distribution coupled to a plurality of electrical energy providers and electrical energy receivers, including one or more hybrid dispensers, in accordance with some embodiments.

FIG. 12C illustrates an exemplary power distribution system comprising one or more hybrid dispensers and coupled to a plurality of electrical energy providers and electrical energy receivers, in accordance with some embodiments.

FIG. 13A illustrates an exemplary hybrid dispenser configured for hydrogen gas refueling and wireless charging via a wireless charging system in a first exemplary configuration, in accordance with some embodiments.

FIG. 13B illustrates a dispenser controller of a hybrid dispenser configured to control hydrogen refueling and wireless charging, in accordance with some embodiments.

FIG. 13C illustrates an exemplary electronics system of a hybrid dispenser configured to provide power to a wireless charging system, in accordance with some embodiments.

FIG. 14 illustrates an exemplary hybrid dispenser configured for hydrogen gas refueling, and wireless and wired charging, in accordance with some embodiments.

FIG. 15 illustrates a wireless charging system of a hybrid dispenser in a second exemplary configuration, in accordance with some embodiments.

FIG. 16 illustrates a wireless charging system of a hybrid dispense in a third exemplary configuration, in accordance with some embodiments.

FIG. 17 illustrates an exemplary charging pad of a wireless charging system for use in a hybrid dispenser and an exemplary charging unit of a vehicle configured to allow for inductive charging of a battery of an electric vehicle, in accordance with some embodiments.

FIG. 18 illustrates an exemplary charging pad of a wireless charging system for use in a hybrid dispenser and an exemplary charging unit of a vehicle configured to allow for bi-directional electrical power exchange via inductive coupling, in accordance with some embodiments.

FIG. 19A illustrates a hybrid dispenser for hydrogen gas refueling and bi-directional wireless and wired electrical power exchange with an electric vehicle, in accordance with some embodiments.

FIG. 19B illustrates an exemplary dispenser controller of a hybrid dispenser configured to control hydrogen gas refueling and bi-directional wireless and wired electrical power exchange with an electric vehicle, in accordance with some embodiments.

FIG. 19C illustrates an exemplary electronic system of a hybrid dispenser configurable to allow bi-directional wireless and wired electrical power exchange with an electric vehicle, in accordance with some embodiments.

FIG. 20 illustrates an exemplary hybrid dispenser for hydrogen gas refueling and bi-directional wireless and wired electrical power exchange with an electric vehicle coupled to, or part of, a power distribution system, in accordance with some embodiments.

### DETAILED DESCRIPTION

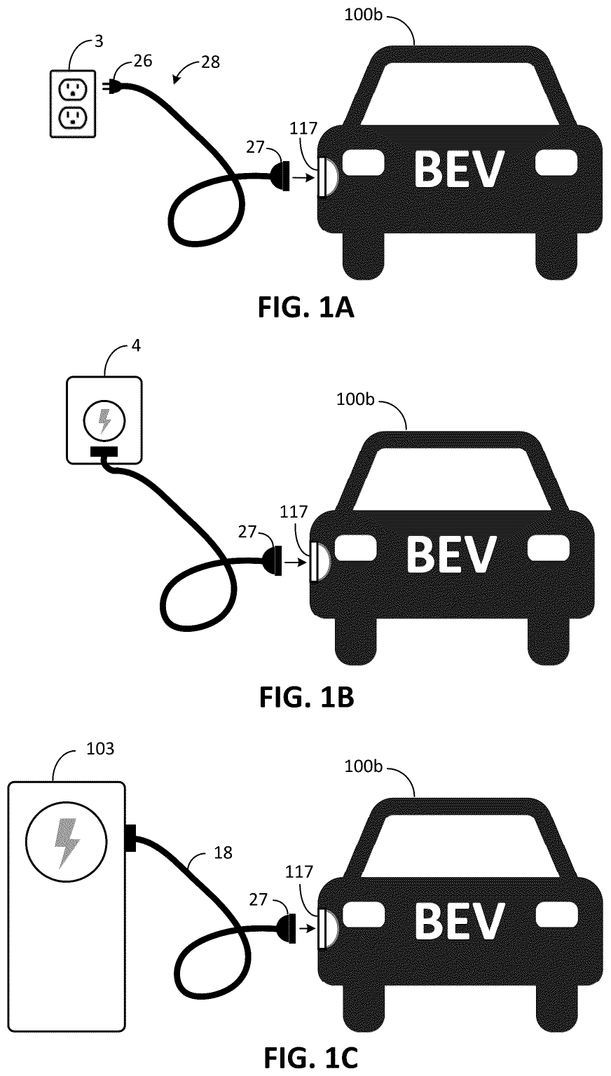

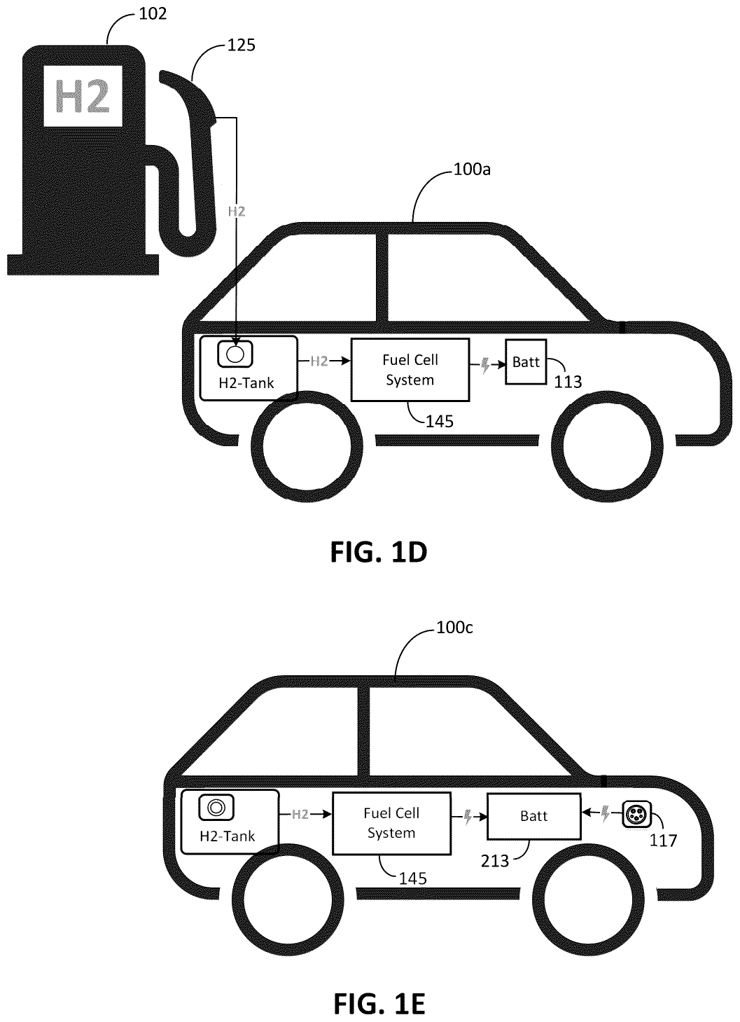

Widespread adoption of EVs depends in part on the ready availability of refueling or recharging stations. More consumers are likely to purchase an EV if consumers can be confident that the EV can be refueled or recharged when and where refueling/recharging is needed. BEVs typically have meaningfully shorter ranges than FCEVs (high-end lithium-ion batteries are now only approaching the range of conventional FCEVs). BEVs typically have long charge times whereas FCEVs can be refueled in timeframes on the same order as gasoline powered vehicles. As discussed above in connection with FIGS. 1A-1C, BEVs can be charged at home with little or no additional equipment and have thus gained traction as passenger vehicles intended for city use, commuting, etc., involving relatively short distances amenable to overnight charging at home when the vehicle is not in use. Availability of public fast DC charging stations, differing charging connector standards, and the still relatively long charging times, have hampered wider adoption of BEVs.

With longer ranges and shorter refueling times, wide-spread adoption of FCEVs has been limited primarily by availability of hydrogen gas refueling facilities. FCEVs have gained traction in fleet operations such as industrial vehicles, public transportation, etc. in which dedicated hydrogen gas refueling installments have been deployed to support those operations. Conventionally, hydrogen refueling dispensers for FCEVs and electric charging stations for BEVs are separate and independent installments, typically deployed at different facilities and locations. The inventors developed hybrid dispensers adapted to allow both refueling of FCEVs and charging of BEV's, examples of which are disclosed in U.S. Pat. No. 11,196,062 ('062 patent), which is herein incorporated by reference in its entirety. Emerging PFCEV technology promises further integration of hydrogen gas and electric charging facilities.

The inventors recognized that hybrid dispensing (hybrid hydrogen gas fueling and electrical charging) techniques can facilitate the use of PFCEVs as a mobile generator and have developed hybrid dispensing methods and apparatus configured to refuel and/or recharge EVs (FCEVs, BEVs and PFCEVs) and configured to receive electrical power from PFCEVs, thus enabling the use of PFCEVs as mobile generators. Utilization of PFCEVs as an electrical power providers according to techniques described herein facilitates resiliency in electrical infrastructure by providing electrical power in circumstances in which electrical power received from one or more primary electrical power providers is disrupted and/or facilitates the ability to provide electrical power to electrical power receivers where no electrical infrastructure is provided or power from the electrical infrastructure has been disrupted or is otherwise unavailable or compromised, examples of which are described in further detail below.

Additionally, hybrid dispenser methods and apparatus described herein may utilize PFCEVs as an electrical power provider to support electrical infrastructure during periods of high demand, for example, by powering one or more electrical power receivers via PFCEVs instead of drawing power (or by drawing less power) from the electrical infrastructure to decrease the load on the electrical infrastructure, providing electrical power back to the electrical infrastructure for distribution to support periods of high demand, etc. According to some embodiments, electrical power from PFCEVs may be utilized during periods in which electrical infrastructure usage rates are high to reduce costs and make more efficient use of available electrical power resources. In this way, aspects of PFCEV utilization may be employed in response to electrical disturbances in electrical infrastructure (e.g., power loss), where electrical infrastructure is not available, to support the electrical infrastructure and/or when PFCEV electrical power may be more cost effective or efficient.

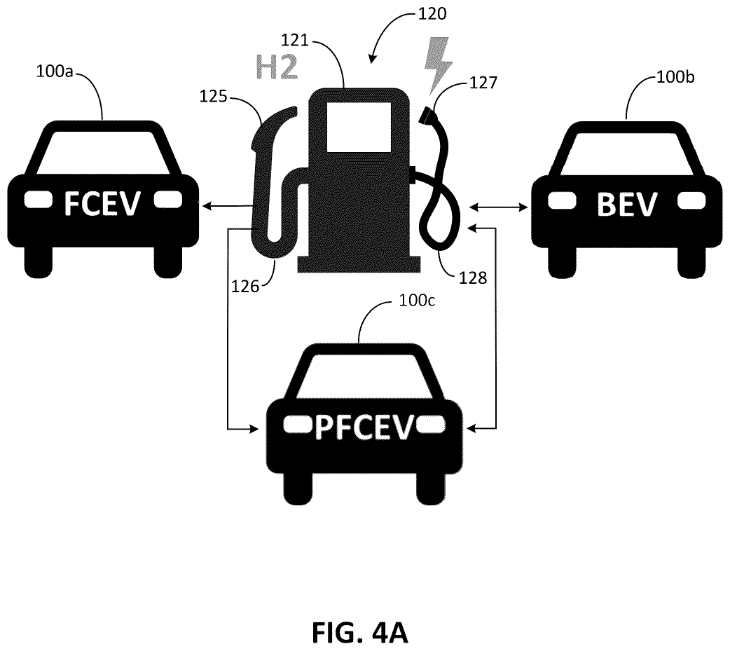

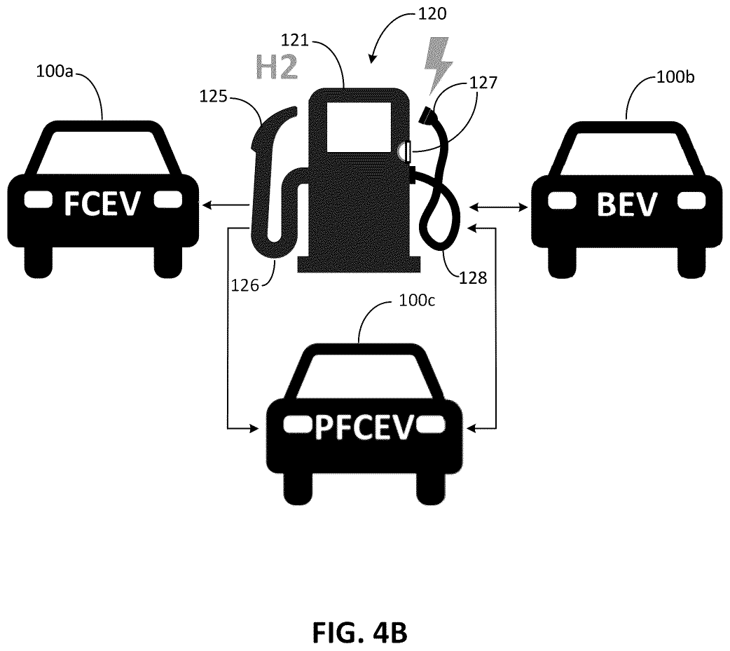

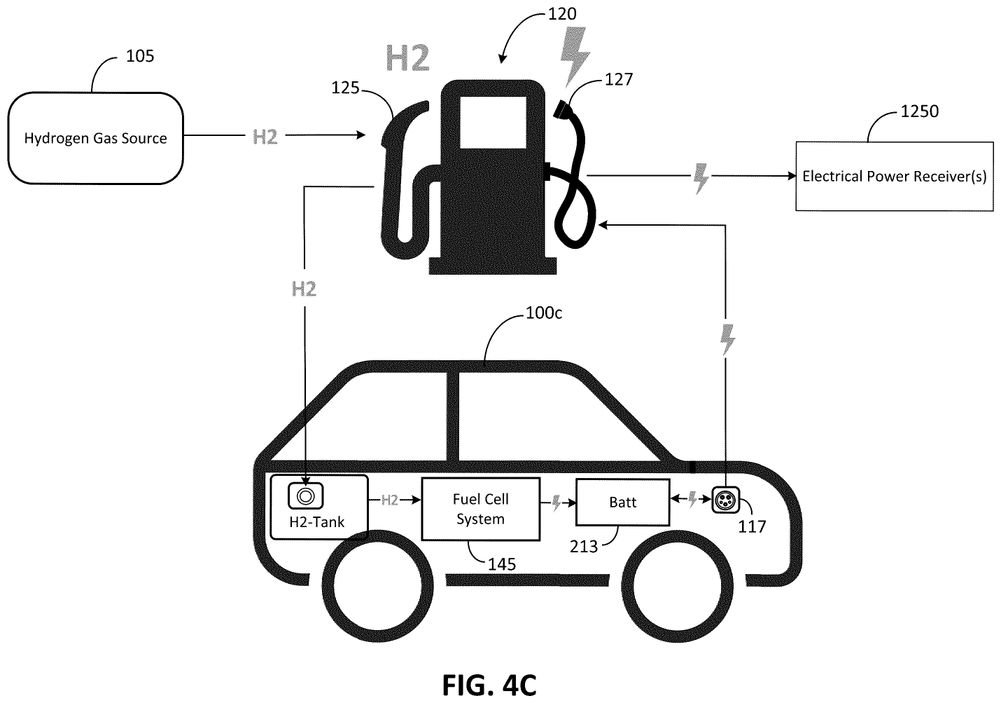

FIG. 4A illustrates an exemplary hybrid dispenser 120 configured to utilize EVs as an electrical power source (e.g., as a mobile generator), according to some embodiments. For example, hybrid dispenser 120 is configured to dispense hydrogen gas to FCEVs and PFCEVs, such as FCEV 100a and PFCEV 100c, via one or more hydrogen gas nozzles 125 coupled to dispenser housing 121 (e.g., via one or more respective hoses 126). Hybrid dispenser 120 may, for example, include any one or combination of the components of the hydrogen dispensers described in the '062 patent and/or in U.S. Publication No.: 2022/0153568 ('568 publication), which is herein incorporated by reference in its entirety.

Hybrid dispenser 120 is also configured to dispense electrical power to charge EVs, such as BEV 100b and PFCEV 100c, via one or more electrical connectors 127 coupled to dispenser housing 121 (e.g., via one or more respective electrical cables 128) to provide electrical power to perform alternating current (AC) charging, direct current (DC) charging, combination AC/DC charging, etc. The term electrical connector (or simply connector) refers herein to a set (i.e., one or more) of terminal connections which can be female (e.g., socket-connections) or male (e.g., a plug-connections) configured to mate with a reciprocal or corresponding connector to establish an electrical connection through which electrical power may be provided. As illustrated in FIG. 4B, one or more electrical connectors 127 may be provided on housing 121 to which an electrical cable having connectors on both ends can be connected to charge an EV (e.g., an electrical cable having a male connector on one end to plug into a female connector provided at the dispenser and a female connector on the other end to plug into a male connector on the electrical port of the EV). As discussed in further detail below, a connector may also include one or more data connections for exchanging data, such as control information, information about hybrid dispenser and/or EV capabilities, signaling between the hybrid dispenser and the EV, etc.

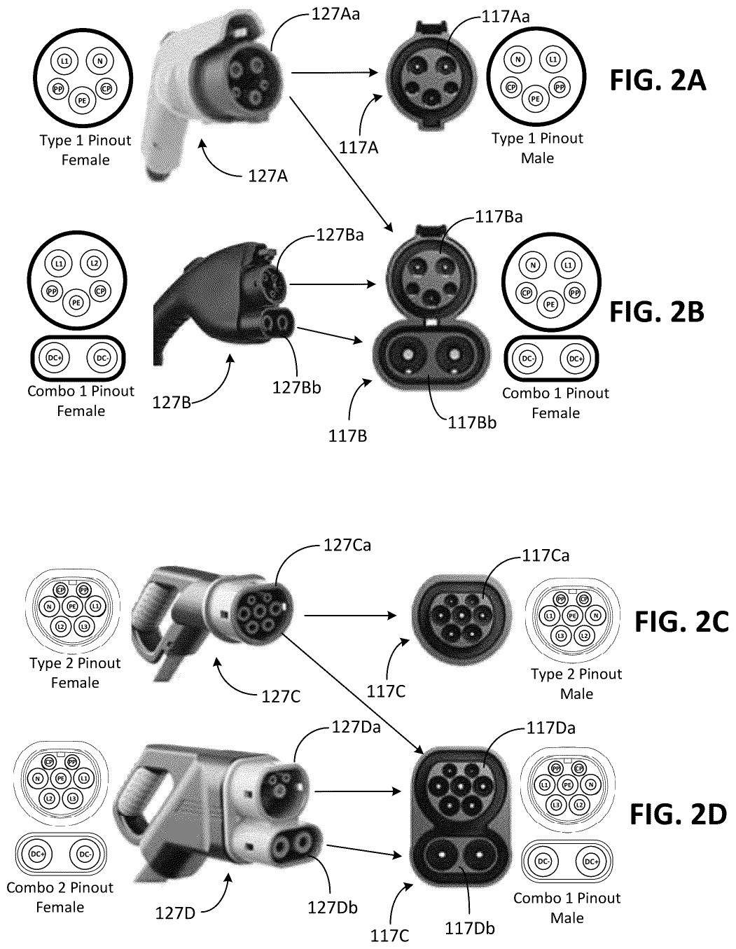

The connector coupled to the end of an electrical cable that plugs into the EV (whether the electrical cable is permanently attached to a charging station or plugged into a connector on the hybrid dispenser itself) is sometimes referred to generically as a “plug” even though the charging connector is conventionally female while receiving connectors on an EV are conventionally male in commonly adopted connector types, examples of which are described in FIGS. 2A-2D below. For example, FIG. 2A illustrates a charging connector 127A comprising socket-connections 127Aa and EV port connector 117A comprising plug-connections 117Aa, referred to as Type 1 connectors (e.g., the SAE J1772 Type 1 connector) configured to provide single-phase AC charging. As illustrated by the Type 1 pinout (female) for connector 127A, the Type 1 socket-connector provides a first line single-phase AC socket-connection (L1), a second line single-phase AC or neutral socket-connection (N), a protective earth socket-connection (PE), a proximity pilot socket-connection (PP) for pre-insertion signaling and a control pilot socket-connection (CP) for post-insertion signaling. As illustrated by the Type 1 pinout (male) for connector 117A, the Type 1 plug-connector provides plug-connections that mirror the socket-connection for proper mating of the connections when plugged-in. The Type 1 connector can be used for both Level 1 charging (e.g., 120 VAC charging in which the “N” connection is neutral) and Level 2 charging (e.g., 240 VAC charging in which the “N” connection provides a second single-phase AC line connection).

FIG. 2B illustrates a combined charging system (CCS) charging connector 127B comprising combination socket-connections 127Ba and 127Bb and a CCS port connector 117B comprising combination plug-connections 117Ba and 117Bb, referred to as Combo 1 connectors. The Combo 1 connectors include two high current DC connections (DC+ and DC−) for fast DC charging (sometimes referred to as Level 3 charging). Typically, the CCS charging connector 127B has socket receptacles for proper mating but without L1 and N/L2 electrical connections (e.g., the socket receptacles are not populated with L1 and N/L2 pins for providing AC power) when provided on the terminal end of a charging cable, but may include all connections when the connector is provided on the charging station itself.

FIG. 2C illustrates a charging connector 127C comprising socket-connections 127Ca and EV port connector 117C comprising plug-connections 117Ca, referred to as Type 2 connectors (e.g., SAE J3068 standard, IEC 62196, etc.) capable of providing single-phase AC charging, three-phase AC charging, DC-low charging or DC-mid charging. Though provided in a different configuration, the top five connections of the Type 2 connector can be used to provide the charging and signaling functionality of the Type 1 connector (i.e., the L1 and N connections may be used to perform Level 1 or Level 2 AC charging, CP and PP connections are provided for communication/signaling and the PE connection provides protective earth). In addition, the Type 2 connector includes an L2 and L3 connection that together with the L1 and N connection can provide three-phase AC charging (using L1, L2 and L3 as the three-phase AC line connections and the N connection as neutral), DC-low charging (using the L3 and L2 connection for DC+ and DC−, respectively, which can be combined with single-phase AC charging using the N and L1 connections) and DC-mid (using the N and L3 connections for DC+ and the L1 and L2 connection for DC−). FIG. 2D illustrates a CCS charging connector 127B comprising combination socket-connections 127B a and 127Bb and a CCS port connector 117B comprising combination plug-connections 117B a and 117Bb, referred to as Combo 2 connectors. The Combo 2 connectors add the two high current DC connections (DC+ and DC−) for fast DC charging.

Hybrid dispenser 120 may include any number or type of connectors 127, either via a connector 127 on the terminal end of an electrical cable 128 that is permanently connected to hybrid dispenser 120 (e.g., as illustrated in FIG. 4A), and/or via a connector 127 provided on housing 121 to which an electrical cable having connectors on both ends can be connected (e.g., as illustrated in FIG. 4B), to provide the desired charging capabilities for a given implementation of a hybrid dispenser, including any of the connectors illustrated in FIGS. 2A-2D. The number and types of connectors 127 of a given hybrid dispenser implementation may be chosen to meet the needs of the hybrid dispenser and may depend on the country or region in which the hybrid dispenser 120 is to be deployed and/or the intended use for which hybrid dispenser 120 is designed (e.g., at a fueling station, an office building, residential home, etc.). The one or more connectors 127 may be female connectors, male connectors, or a combination of both, to meet the design requirements of the hybrid dispenser.

In addition to dispensing hydrogen gas and providing electrical power, hybrid dispenser 120 is configured to receive electrical power from the EV (e.g., from the battery of a BEV or PFCEV and/or from the power system of a PFCEV that is connected to both the fuel cell system and the battery system of the vehicle, as discussed in further detail below). As indicated by the bi-directional arrows between hybrid dispenser 120 and EVs 100b and 100c illustrated in FIGS. 4A and 4B, electrical power can be delivered from hybrid dispenser 120 to an EV via a connector 127 for charging and electrical power can be received by hybrid dispenser 120 from an EV via a same or different connector 127 when the EV is being utilized as an electrical power provider. In this way, hybrid dispenser 120 is capable of bi-directional power exchange with EVs, facilitating the use of EVs as power sources. For example, hybrid dispenser 120 is capable of utilizing PFCEV 100c as a mobile generator fueled by hydrogen gas, examples of which are described in further detail below. To implement bi-directional power exchange, hybrid dispenser 120 may include one or more bi-directional connectors 127 and/or one or more connectors 127 that are dedicated for either delivering or receiving power, respectively.

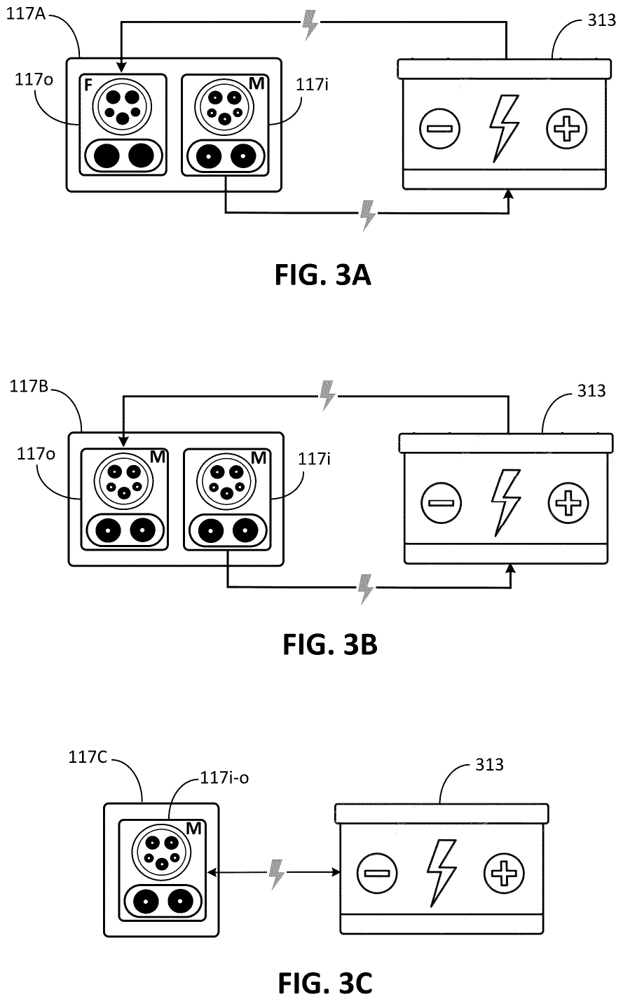

As illustrated in FIGS. 3A-3C, EVs configured for both receiving electrical power for charging and for providing electrical power stored in the EV's battery may implement this bi-directional capability in a number of ways. For example, as illustrated in FIG. 3A, an EV may include an electrical port having a male inlet connector 117i for receiving electrical power to charge battery 313 and a female outlet connector 117o for providing electrical power from battery 313. FIG. 3B illustrates an electrical port 117B with similar separate inlet and outlet connectors 117i and 117o, but where both connectors are male. FIG. 3C illustrates an electrical port 117C having a bi-directional male connector 117i-o that can be configured to both receive electrical power for charging battery 313 and provide electrical power from battery 313. The EV may be configured to switch between a charging mode and a generator mode in any suitable way.

It should be appreciated that the connectors illustrated FIGS. 3A-3C represent connectors generally and are not intended to specify any particular connector-type or standard, nor do the schematic illustrations limit the type of connectors that may be used and accommodated by a hybrid dispenser. Additionally, for each of the exemplary electrical ports in FIGS. 3A-3B, the illustrated male and female connectors may be the opposite of what is illustrated, for example, depending on the standard adopted for different regions/countries, etc. Additionally, the electrical ports illustrated in FIGS. 3A-3C are illustrated as connecting to the EV's battery, but the electrical ports may alternatively or additionally be connected to a fuel cell system of the vehicle or a power system of the vehicle that is coupled to the battery system of the vehicle, the fuel cell system of the vehicle, or both, depending on the design of the vehicle. Thus, FIGS. 3A-3C illustrate different configurations of electrical ports through which electrical power can be provided to and received from the vehicle independent of how the internal power system of the vehicle is implemented.

Thus, a hybrid dispenser 120 may include connector(s) 127 to allow for bi-directional power exchange with any of the exemplary electrical ports illustrated or any type of electrical port that may be adopted. In particular, hybrid dispenser 120 may be configured with one more bi-directional connectors 127 and/or one or more dedicated connectors 127 for providing and receiving electrical power, respectively, to provide desired charging capabilities and to receive electrical power according to one or more different electrical port configurations provided by EV manufacturers. Different hybrid dispensers 120 may be configured in different ways to suit the needs of a particular implementation. The capability of hybrid dispenser 120 to exchange electrical power bi-directionally facilitates utilizing PFCEVs as a power source and, more particularly, as a mobile generator fueled by hydrogen gas to provide renewable power as needed, for example, to power one or more dispensers, a fueling station, building, residential homes, to support electrical infrastructure, to provide power back to the utility grid (e.g., for grid stabilization), etc., some examples of which are discussed in further detail below.

Thus, according to some embodiments, hybrid dispenser 120 may be configured to provide electrical power to connector(s) 127 in a first mode (e.g., to charge one or more batteries of an EV) and may be configured to receive electrical power from connectors 127 in a second mode (e.g., to receive power from one or more batteries of an EV), which electrical power may be used to power one or more electrical components, stored in one or more electrical storage devices, provided to one or more electrical networks (e.g., a local mains electricity network, a secondary electrical network, the utility grid, etc.). Because PFCEVs comprise multiple energy systems, i.e., a fuel cell system and a battery system, hybrid dispenser 120 may utilize PFCEVs as a mobile electric power generator for extended periods of time well beyond the storage capacity of the battery by fueling the PFCEV with hydrogen gas that in turn can be converted to electrical power by the PFCEV's fuel cell system and provided to recharge the battery or provided externally via the vehicle's electrical port. Hybrid dispenser 120 may be used to refuel and/or recharge vehicles for industrial applications (e.g., forklifts, industrial equipment, off-road vehicles, etc.), light duty vehicles (e.g., passenger cars and trucks) and/or medium or heavy-duty vehicles (e.g., busses, freight or long-haul trucks, etc.).

In particular, as illustrated in FIG. 4C, hybrid dispenser 120 includes one or more hydrogen gas nozzles 125 to dispense hydrogen gas from hydrogen gas source 105 to a fuel tank of PFCEV 110c, and further comprises one or more connectors 127 configured to receive electrical power from EVs (which may be the same or different connector(s) 127 configured to provide electrical power to charge EV batteries in a charging mode), as discussed above in connection with FIGS. 4A and 4B. As mentioned in connection with FIGS. 1D and 1E, PFCEV 100c includes a fuel tank for storing hydrogen gas that can be accessed and refueled by engaging a nozzle 125 with a cooperating receptacle of the fuel tank. Some FCEVs include multiple receptacles that can engage with multiple nozzles for simultaneously refueling the vehicle (e.g., heavy duty vehicles such as busses, freight trucks, etc., with large capacity tanks to facilitate faster refueling).

PFCEV 110c also includes an electrical port 117 having one or more connectors to receive electrical power to charge battery 213 (e.g., via a connector 127 of hybrid dispenser 120). As also discussed above in connection with FIGS. 1D and 1E, hydrogen stored in the fuel tank is provided to the hydrogen fuel cell system 145 (e.g., a hydrogen fuel cell stack) that converts hydrogen gas to electricity that can be used to power the motor of vehicle (or any other electrical components) and/or charge battery 213. Charge stored in battery 213 can likewise be used to power the motor or other electrical components of the vehicle. In this way, PFCEV 100 can be operated using hydrogen fuel cell 145 (e.g., operated in the manner of a FCEV), operated using battery 213 (e.g., operated in the manner of a BEV), or operated using both fuel cell system 145 and battery 213 as the electrical power source to operate the vehicle.

PFCEV 100c illustrated in FIG. 4C is also configured to provide electrical power via electrical port 117. For simplicity, electrical port 117 is illustrated as including a single bi-directional connector that provides received electrical power to charge battery 213 in a first mode of operation (e.g., a charging mode) and provides electrical power from battery 213 or fuel cell system 145 in a second mode of operation (e.g., a generator mode during which PFCEV 100c is being used as an electrical power provider). However, electrical port 117 may include multiple connectors in any configuration, including bi-directional connector(s) and/or separate connectors for receiving power to charge battery 213 and to provide power from battery 213 (e.g., any of the configurations illustrated in FIGS. 3A-3C or any other suitable electrical port configuration that provides both electrical inlet and outlet capabilities). In addition, electrical port 117 is illustrated as connected to battery 213, but electrical port 117 may be additionally connected to fuel cell system 145 to provide electrical power from the fuel cell system 145 to the hybrid dispenser.

According to some embodiments, electrical port 117 may be coupled to the power system of PFCEV 100c configured to draw power from both fuel cell system 145 and battery 213 to operate the vehicle as discussed above. When the vehicle is utilized as an electrical power source, the electrical power provided via electrical port 117 is receive from the power system, which may provide electrical power from fuel cell system 145, battery 213, or both. Accordingly, depending on the design of the vehicle, the electrical power received from the vehicle may be from the fuel cell system 145, the battery 213, or both. Thus, receiving electrical power from a vehicle as used herein means receiving electrical power from any one or combination of electrical power sources of the vehicle.

In this manner, both hybrid dispenser 120 and PFCEV 100c are configured to operate in two modes: (1) as a power source that delivers electrical power to the other; or (2) as a power receiver that receives power from the other. In the exemplary second mode illustrated in FIG. 4C, an appropriate connector 127 is connected to a corresponding connector on electrical port 117 of PFCEV 100c to receive electrical power from the vehicle, some of which may then be provided to one or more electrical power receivers 1250. Thus, hybrid dispenser 120 is capable of utilizing PFCEV 100c as a power source to provide power where needed, for example, to power the hybrid dispenser itself, to power one or more other dispensers or charging stations, to provide power to electrical infrastructure (e.g., the local mains electrical network, the utility grid, etc.) to provide power in response to an event that results power loss or instability or to support electrical infrastructure during periods of high demands.

Because hybrid dispenser 120 can both dispense hydrogen gas to the fuel tank of PFCEV 100c and receive electrical power from the PFCEV, hybrid dispenser can effectively utilize PFCEV 100c as a power source for extended periods (e.g., as long as hybrid dispenser 120 has hydrogen gas available from hydrogen gas source 105), even in circumstances where a power failure event effects hybrid dispenser 120. Specifically, as hybrid dispenser 120 draws electrical power from the vehicle, hydrogen gas can be dispensed to PFCEV 100c, which in turn can be converted to electricity by hydrogen fuel cell system 145 that may be used to charge battery 213 so that battery 213 can continue to deliver electrical power to hybrid dispenser 120, or electrical power generated by hydrogen fuel cell system 145 may be provided directly to the hybrid dispenser via the electrical port (e.g., via the vehicle's power system) and bypass battery 213, or electrical power from both battery 213 and fuel cell system 145 may be provided to the hybrid dispenser via the connection at the electrical port. Hybrid dispenser 120 may then deliver the power received from the vehicle to any electrical power receiver 1250 in need of electrical power.

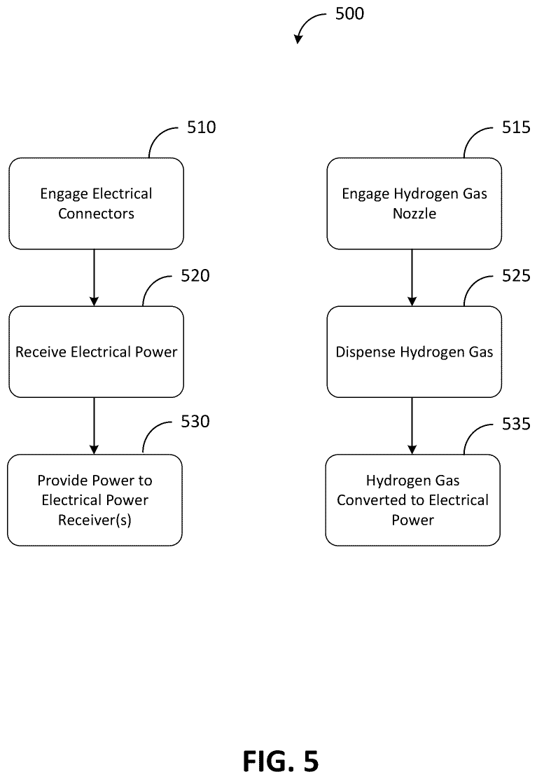

A small amount of the power received from PFCEV 100c may be used to power the electrical components of hybrid dispenser 120 needed to dispense hydrogen gas to PFCEV 100c to continue the process in a self-sustaining loop of energy conversion and electrical power delivery. The remaining electrical power received by hybrid dispenser 120 from PFCEV 100c can be distributed to one or more other electrical energy receivers, including electrical storage devices, electrical components, electrical infrastructure, etc. It should be appreciated that hydrogen gas source 105 may include any one or combination of hydrogen gas sources. For example, hydrogen gas source 105 may include one or more hydrogen storage tanks provided external to hybrid dispenser 120 (e.g., using any of the hydrogen gas storage systems described in the '568 publication) and/or may include one or more hydrogen storage tanks internal to hybrid dispenser 120 (e.g., as in standalone appliances described in the '062 patent in which internal tanks are replenished with a built-in electrolysis system, for example). Hydrogen gas source 105 may also include a transportable hydrogen gas source (e.g., a tube trailer as discussed below) that can be brought in to support extended periods of utilizing one or more PFCEVs as mobile electrical generators (e.g., in the event of an extended power outage). Example methods of a hybrid dispenser utilizing PFCEVs as a mobile generator are described in connection with FIGS. 5-9.

FIG. 5 illustrates an exemplary method 500 at least partially performed by a hybrid dispenser having at least one first hydrogen gas nozzle configured to dispense hydrogen gas and at least one electrical connector configured to provide and/or receive electrical power, in accordance with some embodiments. In act 510, an electrical connection is made between an electrical connector of the hybrid dispenser and a connector of a vehicle capable of delivering power from one or more batteries of the vehicle. For example, a connector provided on the terminal end of an electrical cable connected to the hybrid dispenser may be plugged into a reciprocal connector provided on the electrical port of the vehicle that is configured to provide electrical power from the vehicle (e.g., a bi-directional connector or connector dedicated for providing electrical power from the vehicle's battery, fuel cell system, etc.). As another example, an electrical cable having connectors at both ends may be plugged into a connector (e.g., a socket outlet) provided by the hybrid dispenser (e.g., on the dispenser housing) and plugged into the vehicle's connector configured to deliver electrical power. In act 520, electrical power is received by the hybrid dispenser from the vehicle via the electrical connection between the hybrid dispenser connector and the vehicle connector.

In act 530, at least some of the electrical power received by the hybrid dispenser is provided to one or more electrical power receivers to provide electrical power thereto. For example, the one or more electrical power receivers may include any one or combination of an electrical component or collection of electrical components, electrical infrastructure, a power distribution network, electrical storage device, etc., exemplary embodiments of which are discussed in further detail below. In this manner, the hybrid dispenser can utilize the vehicle as a source of electrical power, for example, as a mobile generator to provide power to electrical power receivers in need, such as during electrical disturbance, power failure and/or during periods of grid instability or periods of high demand, though the aspects of utilizing a vehicle to provide power is not limited to any particular event or set of circumstances.

In act 515, a hydrogen gas nozzle of the hybrid dispenser is engaged with a hydrogen gas fuel tank of the vehicle. For example, the vehicle may be a PFCEV having one or more hydrogen fuel cells configured to convert hydrogen gas to electrical energy to provide power to the vehicle (e.g., the motor and/or one or more electrical components of the vehicle) and to provide electrical power to the one or more batteries of the vehicle (e.g., to charge the battery system of the vehicle). According to some embodiments, more than one hydrogen gas nozzle is engaged with a vehicle. In particular, some vehicles may include more than one receptacle through which the vehicle can be refueled simultaneously as is often the case with medium or heavy-duty vehicles with large storage capacities (e.g., busses, large trucks, etc.) to facilitate faster refueling of such vehicles. However, any type of vehicle may include multiple receptacles and multiple nozzles may be engaged with such vehicles in act 515. In act 525, hydrogen gas is dispensed from the hybrid dispenser to the vehicle via the one or more hydrogen gas nozzles engaged with the vehicle.

In act 535, the hydrogen fuel cell system of the vehicle provides electrical power to the power system (e.g., the battery system or the power system to which the battery and the fuel cell system are connected) from which the hybrid dispenser receives electrical power. In this manner, hybrid dispenser can both receive power from the vehicle (e.g., the battery system, the fuel cell system or both) and dispense hydrogen gas to the vehicle that can in turn be converted by the vehicle's fuel cell system to electrical power to charge the battery or provided to hybrid dispenser via the electrical port (e.g., via the vehicle's power system that routes the electrical power to the electrical port from the battery, the fuel cell system, or both), thus allowing the hybrid dispenser to utilize the vehicle as an electrical power source for an extended period of time, e.g., as a renewable mobile generator.

The exemplary acts of method 500 illustrated in FIG. 5 can be performed in any suitable or desired order. For example, in some embodiments, acts 510-530 are initiated and performed first and acts 515-535 are initiated and performed subsequently, e.g., shortly thereafter, when the one or more batteries need charging and/or when it is otherwise desirable to begin recharging of the one or more batteries that are delivering electrical power. In some embodiments, acts 515-535 are initiated and performed first and acts 510-530 are initiated and performed subsequently, e.g., shortly thereafter, when the one or more batteries are sufficiently charged, when the hydrogen fuel tank has been filled, etc. In some embodiments, acts 510-530 and acts 515-535 are initiated and performed substantially concurrently. Independent of which acts are initiated first or concurrently, any of the acts may continue to be performed concurrently, or any of the acts may be performed iteratively or in alternation.

For example, according to some embodiments, hydrogen gas may be dispensed to the fuel tank of the vehicle until the fuel tank is full, after which act 525 ends (and the hydrogen gas nozzle may be disengaged with the vehicle). The fuel cell system may convert hydrogen gas to electrical power during and after the fuel tank is being filled, or act 535 may be initiated only after the fuel tank is filled with hydrogen. Similarly, the hybrid dispenser may receive electrical power from the vehicle (act 520) concurrently with dispensing hydrogen gas to the vehicle (independent of which act was initiated first) or any of the exemplary acts may be alternated and/or performed iteratively as needed or desired. For example, the hybrid dispenser may dispense hydrogen gas (act 525) for a period of time, cease dispensing hydrogen gas (e.g., when the fuel tank is full) and resume dispensing hydrogen gas again (e.g., when the fuel tank is low) any number of times while electrical power is being received from the vehicle (act 520). As another example, hybrid dispenser may dispense hydrogen gas (act 525) at low flow rates throughout (or through an extended period of time) when electrical power is being received from the vehicle (e.g., to facilitate ambient hydrogen gas refueling), which low flow rate fills may also be initiated, terminated and repeated as desired. Likewise, any of the acts in method 500 can be performed sequentially, concurrently, iteratively and/or in alternation, as the aspects of the hybrid dispenser utilizing the vehicle as an electrical power source are not limited in this respect. According to some embodiments, the hybrid dispenser's controller is configured to automatically perform, terminate and/or repeat the acts of method 500 based on desired functionality. For example, one or more nozzles may be engaged with the vehicle (act 515) one or more electrical connectors may be connected to the vehicle (act 510) and the hybrid dispenser controller automatically determines when to dispense hydrogen gas (and at what flow rates), when to charge the vehicle and/or when to receive electrical power from the vehicle, etc. The hybrid dispenser may be configured to automatically control method 500 based on any number of factors or criteria, some examples of which are discussed in further detail below.

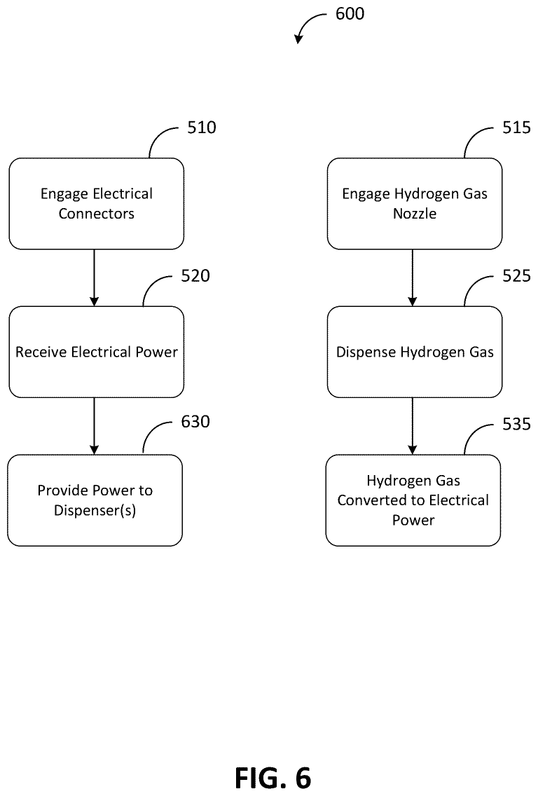

FIG. 6 illustrates a method 600 of a hybrid dispenser utilizing a PFCEV as an electrical power generator, in accordance with some embodiments. As shown, method 600 comprises acts that may be the same or similar to the acts described in connection with method 500 illustrated in FIG. 5. Act 630 is a specific example of act 530 in which electrical power received by the hybrid dispenser (act 520) is provided to one or more electrical power receivers that includes one or more dispensers, for example, the hybrid dispenser itself and/or one or more additional dispensers, which themselves may be hybrid dispensers, hydrogen gas dispensers, electric charging stations and/or petroleum-based dispensers (e.g., gasoline, diesel, etc.). In this way, the hybrid dispenser and/or one or more additional dispensers can operate using power received from the vehicle to which the hybrid dispenser is connected, for example, in the event of a power failure at the power provider from which the hybrid dispenser normally receives power. As a result, even in the event of power loss or disturbance in the electrical infrastructure providing power to the hybrid dispenser (e.g., the mains electrical infrastructure of a fueling station, building or building complex, parking garage, residential home or residential complex, etc.), hybrid dispenser (and any other dispenser) can continue to operate via power received by the hybrid dispenser from the vehicle to which the hybrid dispenser is connected.

Because the amount of electrical power required by the hybrid dispenser to continue the hydrogen gas dispensing operation is significantly less than the energy in the hydrogen gas being dispensed and converted to electrical power by the vehicle's fuel cell system, net electrical power is produced while hydrogen gas is available that can be used to power other dispensers or other electrical power receivers affected by the loss of power (e.g., hydrogen gas cooling systems, pumps, etc.). Some electrical power received by the hybrid dispenser can be stored (e.g., in one or more electrical storage devices, such as one or more batteries within or connected to the hybrid dispenser, one or more connected uninterruptible power supplies (UPS), etc.) and drawn from as needed, including by electric charging stations to recharge the batteries of other electric vehicles and/or some electrical power received by the hybrid dispenser can be directly distributed to other dispensers servicing other vehicles, used to provide power to operate other electrical components as needed.

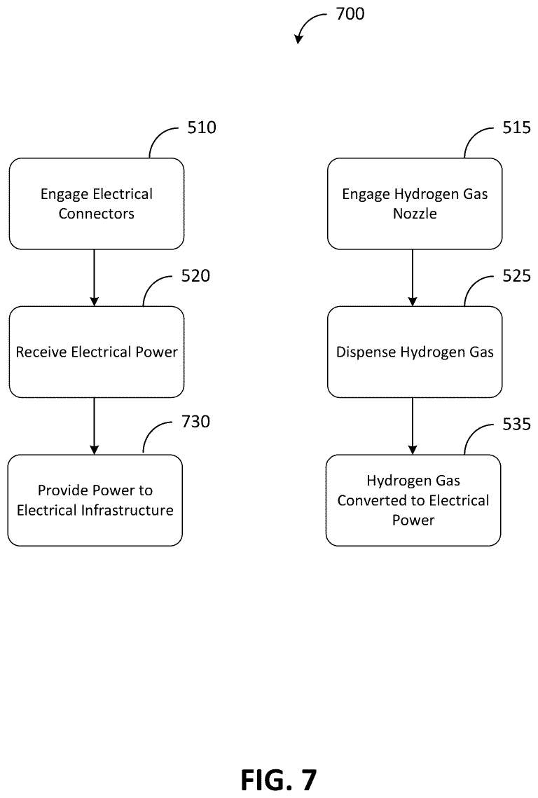

FIG. 7 illustrates a method 700 of a hybrid dispenser utilizing a PFCEV as an electrical power generator, in accordance with some embodiments. As shown, method 700 also comprises acts that may be the same or similar to the acts described in connection with method 500 illustrated in FIG. 5. Act 730 is another example of performing act 530 in which electrical power received by the hybrid dispenser (act 520) is provided to electrical infrastructure that normally provides electrical power to a facility to which a hybrid dispenser is associated (e.g., a fueling station, a building or building complex, residential homes, a factory or industrial complex, etc.). Such facilities typically include electrical infrastructure (e.g., a mains electrical power network) connected to the grid to provide electrical power to electrical power receivers of the facility that are connected to the electrical infrastructure (e.g., lighting, heating, ventilation and air conditioning (HVAC), household, large or industrial appliances, computer networks, etc.). For example, a mains electrical network typically have one or more connections to the grid (e.g., a single-phase or three-phase hook-up to the grid) and power electronics (e.g., power converters) to convert electrical power received from the grid to distribute electrical power at the voltage/current levels needed by the facility (e.g., according to local, regional or national electrical power standards, or according to a proprietary standard needed by a particular facility, such as specialized industrial complexes, factories, etc.).

By utilizing hybrid dispenser techniques discussed above (e.g., by performing method 700), the electrical power infrastructure servicing a facility at which one or more hybrid dispensers are located can be made resilient by providing electrical power received from PFCEVs to the electrical infrastructure when an event within the local power network (e.g., the mains electrical network) or at the utility grid results in loss of power. During the event (e.g., a power outage), electrical power received by one or more hybrid dispensers from one or more PFCEVs may be provided to the electrical infrastructure to operate one or more electrical components connected thereto in much the same way as an auxiliary power generator steps in to provide electrical power in the event the primary power source is disrupted (e.g., a disturbance or failure at some location on the grid, local failure at the local mains electrical network, etc.). In this way, the electrical power infrastructure of a fueling station, office building or complex, parking garage, residential complex or individual residential home can be made resilient and one or more electronic components connected to the electrical infrastructure can continue receiving power during a power outage or disturbance.

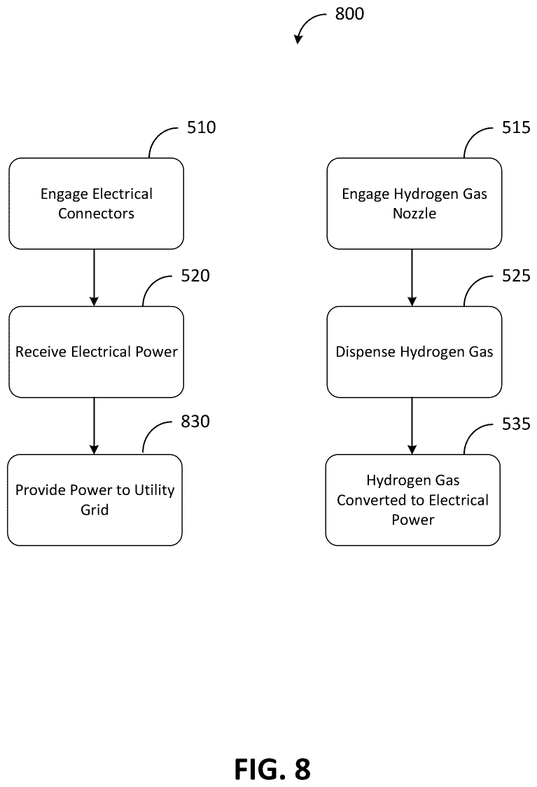

FIG. 8 illustrates a method 800 that utilizes hybrid dispenser techniques to assist in stabilization of the utility grid. Typical utility grids comprise one or more power producers (e.g., fossil fuel power plants and/or one or more renewable energy power producers such wind or solar, such as a wind turbine farm, a solar panel farm etc.), a primary transmission network (e.g., the grid backbone) and a plurality of secondary (or tertiary, etc.) electrical power networks (such as the example electrical power infrastructure described above) that operate as intermediary or terminal electrical power providers (e.g., a mains electrical network of a building, home, etc.). Events anywhere on the grid can impact the delivery of power to any one or combination of the electrical power networks connected to the grid. For example, lightning strikes may cause the grid to be unstable or result in power loss. Storms or other natural disasters may result in wide-spread power outages or partial grid collapse. Excessive demand from one or more electrical power networks can also cause the grid to be unstable.

As shown, method 700 also comprises acts that may be the same or similar to the acts described in connection with method 500 illustrated in FIG. 5. In act 830 of method 800, one or more hybrid dispensers are configured to receive electrical power from PFCEVs and provide electrical power back to the grid, providing electrical power to stabilize the grid until the cause of the disruption can be resolved. In addition, during peak demand on the utility grid, hybrid dispenser techniques described above (e.g., method 800) may be employed to provide power from one or more PFCEVs to reduce the load on the grid, to provide power back to the grid to assist the power grid in handling periods of high demand and/or to utilize PFCEVs as a power source during periods where grid power usage rates are high as a way of reducing costs.

In this way, hybrid dispenser techniques can be used to provide auxiliary power generation, contribute to grid stabilization and/or assist in avoiding grid collapse, contribute to power production during periods of high demand and/or to deliver cost effective power during times when grid power rates are high. Any of the above-described hybrid dispenser techniques may be used alone or in any combination to utilize PFCEVs as an alternate power source (e.g., as a mobile generator). Any of the above-described methods may be performed using a single hybrid dispenser connected to one or more PFCEVs, or multiple hybrid dispenser connected to one or more PFCEVs to provide a network of mobile generators, as the aspects are not limited in this respect. It should be appreciated that hybrid dispensers described herein may also be used to receive power from BEVs, but the duration for which a BEV can operate as a mobile generator will be capped by the capacity of the battery if fully charged and further limited in duration if not. Any of the above-described methods or acts of the methods may be performed by one or more controllers of the hybrid dispenser implemented in any suitable way using any combination of hardware and/or software controllers, examples of which are described in further detail below.

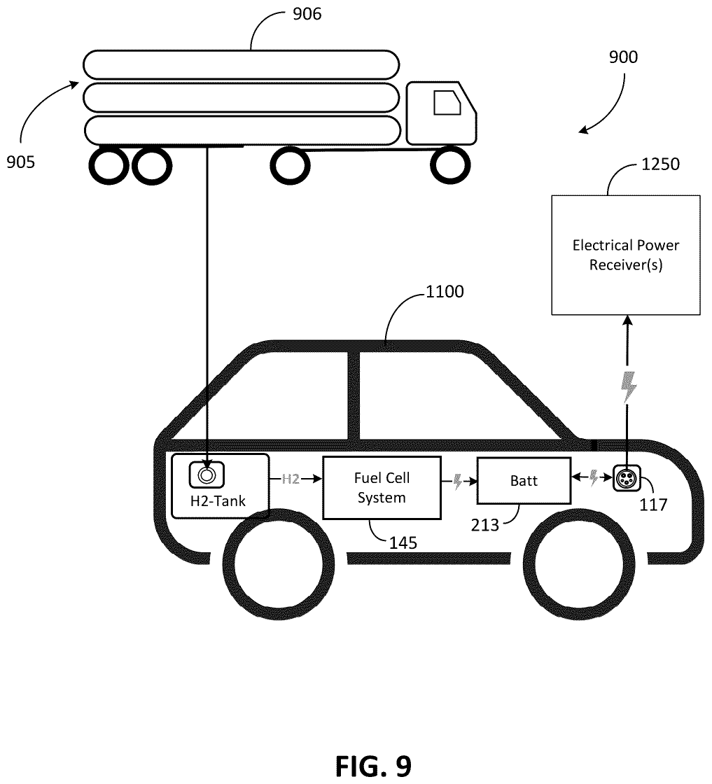

FIG. 9 illustrates a system comprising a transportable hydrogen supply to facilitate utilizing one or more PFCEVs as mobile generators that can be used to provide power at virtually any desired location. In particular, system 900 comprises a transportable or mobile hydrogen supply 905. In exemplary system 900, the transportable hydrogen supply is shown as a tube trailer 906 that can be, for example, attached to a semitruck, tractor-trailer or other suitable freight truck or rig that can pull the tube trailer 906 to desired locations. It should be appreciated that transportable or mobile hydrogen supply may be any suitable type of transportable tank or tanks configured to store hydrogen gas, or may include a dedicated tanker vehicle, etc., as the aspects are not limited to any particular type of transportable or mobile hydrogen gas supply nor to any particular mode of transporting the hydrogen supply.

System 900 further comprises a PFCEV 1100 comprising hydrogen fuel cell system 145 (e.g., a hydrogen fuel cell stack or other component or components configured to convert hydrogen gas into electricity) and battery 213 (or a battery system comprising multiple batteries) coupled to the hydrogen fuel cell system 145, one or both of which is externally accessible via electrical port 117 in the manner discussed above. As also discussed above, vehicle 1100 is configured to have a mode in which electrical power can be provided from the vehicle via a connector provided on electrical port 117 (e.g., a same or different connector by which battery 213 can be charged). In system 900, an electrical connection is made between PFCEV 1100 and one or more electrical power receivers 1250 via an electrical cord or cable having a connector at one end configured to mate with a connector on the vehicle's electrical port 117 and a connector on the other end configured to mate with a connector of one or more power receivers 1250 or an intermediary electronic component to which one or more power receivers 1250 can be connected (e.g., a surge protector, power strip, adapter or adapter cable, etc.).

In this way, the electrical connection between PFCEV 1100 and target power receiver(s) may be made by daisy-chaining one or more components having the appropriate connectors necessary to deliver power to the desired power receivers(s) 1250. For example, an electrical cable having a connector configured to mate with a connector provided on electrical port 117 and a socket connector on the other end configured to receive standard two or three prong plugs (or any type of plug) may be used to allow a direct plug-in connection to target power receivers 1250, or to connect to an adapter, power strip having multiple electrical connectors of same or different types, a power converter, etc., capable of connecting to and providing electrical power from the PFCEV 1100 to target power receiver(s) at rated power levels. The terminal end of the electrical cable may alternatively have a plug connector adapted to directly plug into target power receivers 1250 or to plug into adapters, power strips or supplies, power converters, etc. that are adapted to connect to target power receivers 1250. Power receivers 1250 may be, for example, any one or combination of electrical components (e.g., electrical equipment such as battery-powered generators (to extend the duration in which they can be operated), pumps, electrical appliances, medical equipment, rescue equipment, lighting, etc.), electrical infrastructure that has experienced power loss or disruption, etc.

Transportable/mobile hydrogen supply 905 includes one or more means for dispensing the stored hydrogen gas (not shown) to PFCEVs, for example, one or more hoses and nozzles configured to engage with and deliver hydrogen gas to the fuel tank of one or more PFCEV 1100. Hydrogen supply 905 may include multiple nozzles of the same type or multiple nozzles of different types to allow hydrogen gas to be dispensed to a wide variety of different types of PFCEVs. In this way, hydrogen supply 905 and any number of PFCEVs can be transported to locations in which electrical power is needed. For example, system 900 can be deployed to provide electrical power to emergency aid or rescue operations, disaster relief and recovery installations, emergency or disaster shelters, etc., in circumstances where electrical power is needed, in locations that are not connected to the grid and/or have no available power source, or at locations where the electrical infrastructure has failed (e.g., as a result of a natural disaster or other grid disturbance or failure.). Thus, a transportable/mobile hydrogen supply can be employed to utilize PFCEVs as an electrical power source in numerous contexts, in a wide variety of circumstances and at virtually any location. Because transportable/mobile hydrogen gas supply 905 can be replaced with another transportable/mobile hydrogen gas supply 905 in the event hydrogen gas is exhausted, system 900 can be used as a mobile power source for extended durations when and if needed (e.g., not only in emergency, rescue or disaster scenarios, but to provide electrical power to or in support of construction sites where electrical infrastructure has not yet been installed, pop-up venues such as off-the-grid music concerts, festivals or events, temporary military bases, etc.).

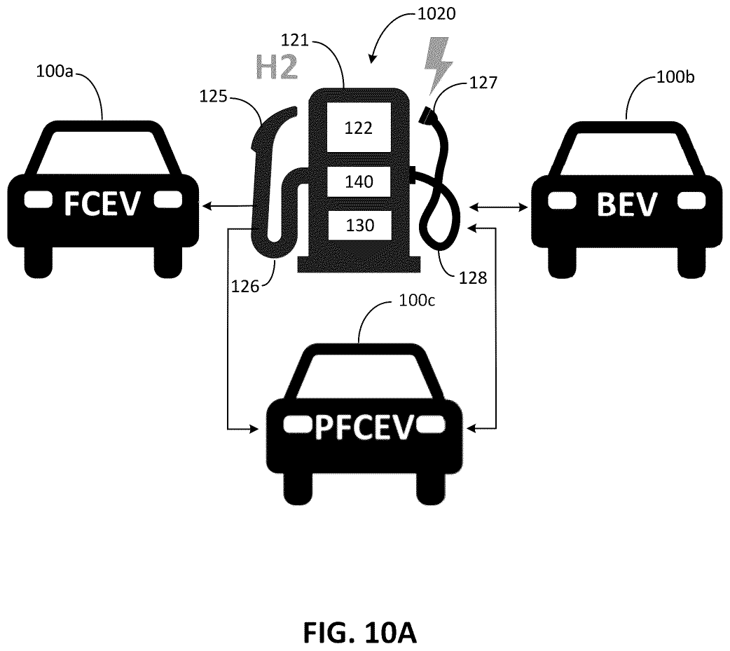

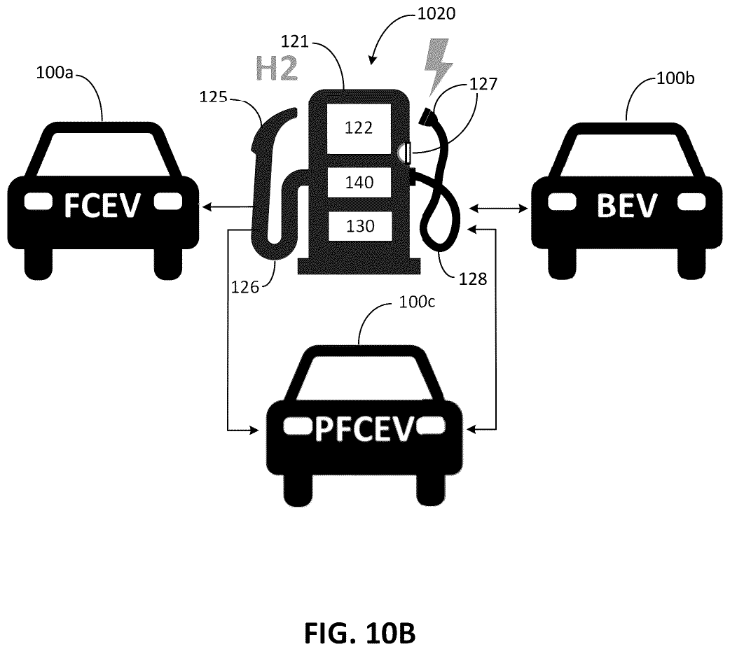

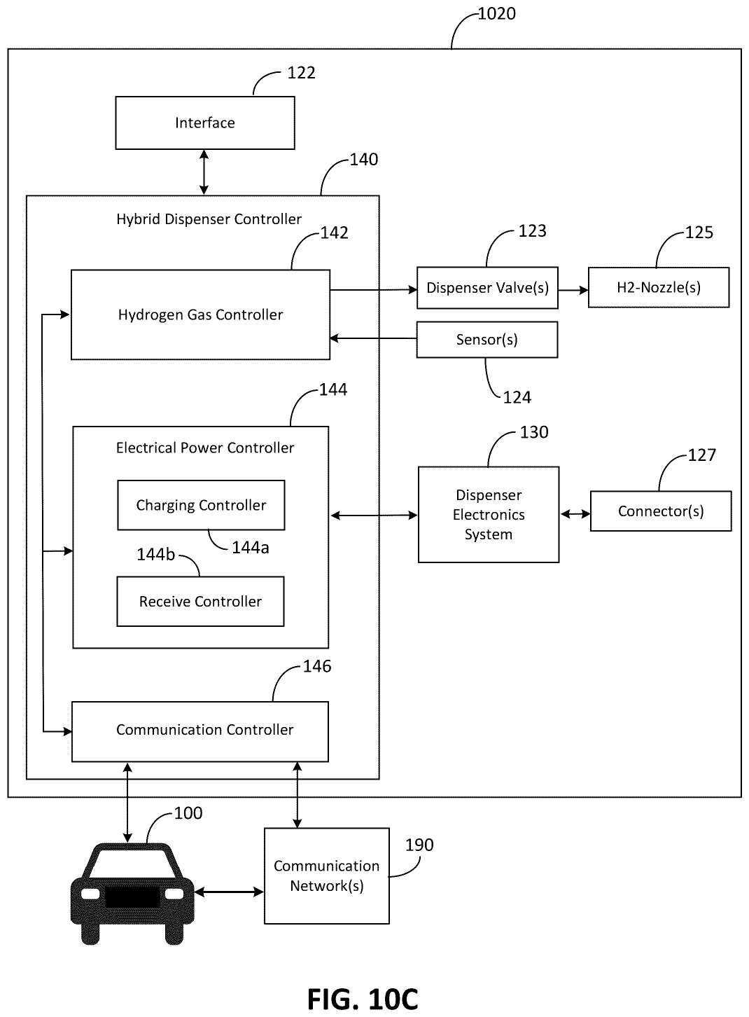

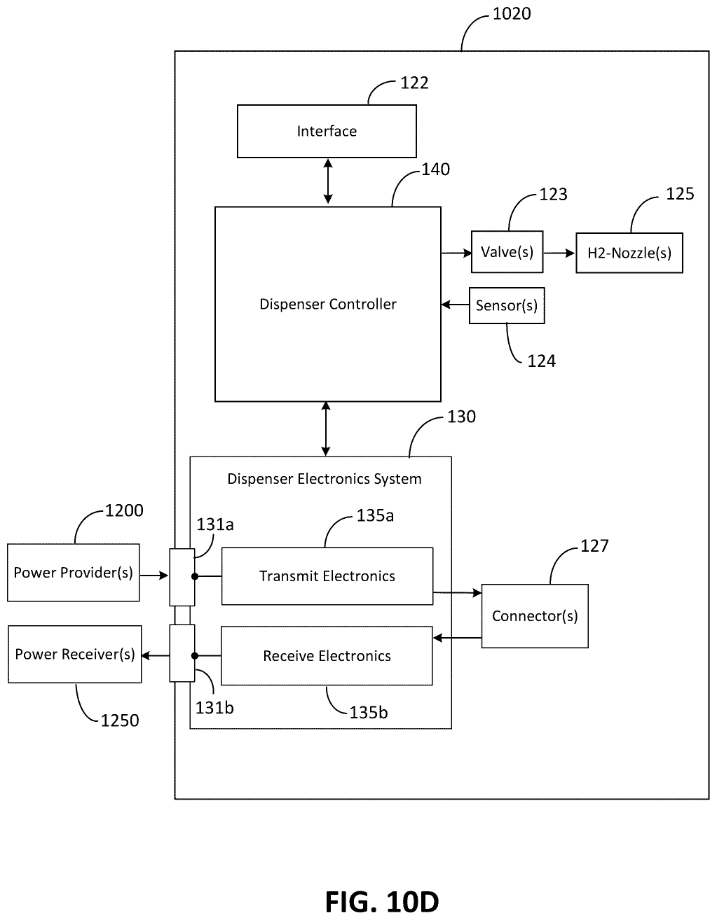

FIGS. 10A-10D illustrate example implementations of hybrid dispensers configured to utilize EVs as an electric power source, in accordance with some embodiments. Like the hybrid dispensers discussed above, hybrid dispenser 1020 comprises one or more hydrogen gas nozzles 125 for dispensing hydrogen gas and one or more connectors 127 configured to exchange electrical power with EVs (e.g., BEV 100b, PFCEV 100c), which connector(s) may be provided on the terminal end of an electrical cable 128 as shown in FIG. 10A and/or provided on housing 121 as shown in FIG. 10B and may be provided in any of the configurations discussed above or in any other suitable configuration to facilitate bi-directional exchange of electrical power.

As illustrated in FIG. 10, hybrid dispenser 1020 comprises hybrid dispenser controller 140 configured to control various operations of the hybrid dispenser. Dispenser controller 140 may be a single controller or multiple controllers that are communicatively coupled together. Dispenser controller 140 may be configured to control the dispensing of hydrogen gas during a hydrogen gas fueling event, for example, by controlling the flow rate of hydrogen gas delivered to the fuel tank of a vehicle (e.g., FCEV 100a, PFCEV 100c, etc.) according to desired fueling protocols. Dispenser controller 140 may be configured to also control aspects of the delivery of electrical power to an EV via electrical connector(s) 127 during a charging event and aspects of receiving electrical power from an EV when the EV is being utilized as an electrical power source by controlling (e.g., configuring) dispenser electronics system 130. Dispenser controller 140 may be configured to control the operation of a dual fueling and charging event and/or control the operation of a hydrogen gas fueling event while a PFCEV is being utilized as an electrical power source. Dispenser controller 140 may also be configured to communicate with one or more communication networks and/or to communicate with a vehicle via one or more communication connections established with the vehicle to exchange information to facilitate a fueling event, a charging event and/or utilizing an EV as an electrical power source (e.g., in a generator mode). The one or multiple controllers forming dispenser controller 140 may be implemented in any suitable way, including as one or any combination of one or more processors, microcontrollers, application specific integrated circuits (ASICS), field programmable gate arrays (FPGAs), etc., or any other suitable software and/or hardware controllers, as the aspects are not limited for use with any particular dispenser controller configuration or implementation.

Hybrid dispenser 1020 further comprises dispenser electronics 130 that may include power electronics, connectors, electrical circuitry, etc., that allow electrical power to be exchanged bi-directionally between hybrid dispenser 1020 and EVs (e.g., BEV 100b, PFCEV 100c, etc.). For example, power electronics system 130 may include one or more power ports to receive electrical power from one or more electrical power providers (e.g., the utility grid, local mains electrical infrastructure, power distribution system, UPS devices, etc.) such as an electrical storage device), may include power electronics to perform any desired or needed power conversion and may include electronic circuitry to provide AC and DC electrical power at the appropriate voltage/current levels to corresponding connectors 127 of hybrid dispenser 1020. Dispenser electronics may further include power electronics and electrical circuitry to receive electrical power via corresponding connector(s) 127 and perform any desired or needed power conversion to provide electrical power to one or more power receivers (e.g., hybrid dispenser 1020, one or more other dispensers or charging stations, an EV via a connector 127 different than the connector 127 via which power is being received, electronic components, electrical infrastructure, etc.). Dispenser controller 140 may be configured to control power electronics system 130 to perform charging events, to receive electrical power from EVs to perform any of the mobile generator methods discussed above (e.g., methods 500-800 discussed in connection with FIGS. 5-8, respectively) and/or to perform dual charging and receive operations.

Hybrid dispenser 1020 may be located at any of a variety of desired locations, including a roadside station (which may include one or more additional hybrid dispensers, one or more hydrogen dispensers and/or one or more electric charging stations), in proximity to a building or complex (e.g., in the parking lot of an office building or complex, shopping mall, event venue, etc.), in a parking garage, in a residential community or at an individual residence. The refueling/recharging capabilities of hybrid dispenser 1020 may be tailored according to the needs and demands of its deployment (e.g., the demands of a hybrid dispenser at a roadside fueling station vs. a residential home). For example, a hybrid dispenser 1020 at a fueling station may be configured to provide single-phase AC charging, three-phase AC charging and fast DC charging and may be configured with the corresponding dispenser electronics system 130 and connectors 127 to allow for charging at any of those levels. A hybrid dispenser 1020 designed for home use may provide single-phase AC charging and include dispenser electronics system 130 and corresponding connectors 127 to allow for single-phase AC charging (e.g., using electrical power from the mains electrical network).

As another example, a hybrid dispenser 1020 designed for home use may include connector(s) 127 provided on the housing 121 of the dispenser that can deliver electrical power at a desired combination of different charging levels depending on the electrical cable that is plugged into the connector(s). In this way, an EV owner can obtain an electrical cable having connectors at each end of the electrical cable to plug into a corresponding connector 127 of hybrid dispenser 1020 and to plug into the owner's specific EV for charging and/or receiving electrical power from the EV. The electrical cable can be replaced (or adapters added) should an EV owner purchase a different EV having different connectors/charging capabilities, or an EV configured to provide electrical power differently, and/or multiple electrical cables can be obtained for EV owners with multiple EVs. A public hybrid dispenser 1020 may include one or more connectors 127 provided on electrical cable(s) that are permanently connected to the hybrid dispenser 1020 and may additionally include one or more connectors 127 provided on the dispenser housing 121 that allow EV owners to use their own cable connections for charging and/or for delivery of electrical power.

As another example, a hybrid dispenser 1020 for private use (e.g., home use, residential complex use) may be configured as a standalone hydrogen dispenser with internal tank(s) that can be refilled via internal electrolyzer units connected to the local power source and water supply (e.g., like example hydrogen dispensers and hybrid dispensers disclosed in the '062 patent), whereas a public hybrid dispenser 1020 (e.g., at a fueling station, office complex, etc.) may be connected to an external hydrogen gas source and may be also be connected to a hydrogen cooling system (e.g., any of the hydrogen dispensing systems described in the '568 publication). However, it should be appreciated that while hybrid dispenser 1020 can be designed with features that meet the specific needs of its deployments, any of the hydrogen dispensing, electrical charging and electrical receiving features may be implemented on a hybrid dispenser independent of its deployment, as the aspects are not limited in this respect.

Hybrid dispenser 1020 may also include interface 122 (e.g., any one or combination of a display, keypad, payment interface, voice interface, etc.) via which users can interact with hybrid dispenser 1020, for example, to select the type of desired dispensing to be performed (e.g., hydrogen gas refueling, electric charging, or both), provide payments, etc. Interface 122 may also provide information to the user, such as current hydrogen gas levels (or other tank parameters of the vehicle), current battery charge, duration of available fueling events (e.g., time required to refuel a hydrogen gas fuel tank according to available fueling protocols, such as ambient or chilled dispensing, time required to charge the battery according to the one or more available charging levels), status of a current refueling event (e.g., an indicator of the percentage of completion, time remaining until completion of a tank refill and/or battery re-charge, etc.). Interface 122 may also be used to switch the hybrid dispenser from a first operating mode in which electrical power is provided to an EV to a second operating mode in which electrical power is received from an EV. It should be appreciated that switching from a first operating mode to a second operating mode may be performed automatically by the hybrid dispenser in response to one or more events (e.g., detection of power loss in a primary provider, determination of high demand or high usage rates on the grid, detection of the engagement of a connector dedicated to receive power or engagement to a vehicle connector dedicated to providing electrical power, signaling from an EV via the connector or via another communication channel established with the EV, etc.).

FIG. 10C illustrates a hybrid dispenser 1020 comprising a dispenser controller 140 implemented in accordance with some embodiments. In particular, the exemplary dispenser controller 140 comprises a hydrogen gas controller 142, an electric power controller 144 and a communication controller 146. It should be appreciated that the different controllers illustrated in FIG. 10C as forming dispenser controller 140 illustrate different control functionality or modules that may be implemented as a single controller or as multiple controllers that are communicatively coupled together to control operations of hybrid dispenser 1020, as the aspects are not limited by the way in which dispenser controller 140 is implemented. In the embodiment illustrated in FIG. 10C, hydrogen gas controller 142 is configured to initiate, control the operation of, and terminate a hydrogen gas fueling event. In particular, hydrogen gas controller 142 may control the operation of one or more valves 123 that govern hydrogen flow through nozzle(s) 125 and into the fuel tank of a vehicle during a fueling event.

Hydrogen gas controller 142 may also be coupled to one or more sensors 124 (e.g., one or more pressure sensors, one or more flow rate sensors, one or more temperature sensors, etc.) to receive sensor signals that controller 142 uses to control the flow of hydrogen gas from a hydrogen gas source (which may be provided internal to hybrid dispenser 1020, external to hybrid dispenser 1020, or both) according to a desired fueling protocol and/or to ensure the safe dispensing of hydrogen gas during the fueling event. Sensor(s) 124 may comprise any one or combination of the above-described exemplary sensors provided upstream of dispenser valve(s) 123, downstream from dispenser valve(s) 123, or both. Hydrogen gas controller 142 may be configured to control the operation of other components of hybrid dispenser 1020 that may be present in a given hybrid dispenser implementation (e.g., one or more compressors, electrolyzer units, etc.). Hydrogen gas controller 142 may be configured to perform any of the hydrogen gas dispensing control techniques described in the '062 patent and/or '568 publication using any of the valve systems described therein (e.g., a bank of fixed-sized valves, a variable-sized valve, etc.) to control the flow rate of hydrogen delivered to the fuel tank according to desired fueling protocol(s), either in connection with ambient temperature fueling events or chilled hydrogen gas fueling events. Hydrogen gas controller 142 may be configured to perform any safety checks needed prior to initiating a fueling event (e.g., safety checks for combustible gas, ambient temperature checks, cooling system checks if hydrogen pre-cooling is used), may be configured to monitor the fueling event to safely control the fueling event and/or terminate the fueling event, etc. Hydrogen gas controller 142 may also be configured to receive information about the vehicle to determine an appropriate fueling protocol, for example, via communication controller 146 discussed in further detail below.

Dispenser controller 140 may further comprise electrical power controller 144 configured to control the delivery of power via connectors(s) 127 during a charging event (e.g., via charging controller 144a) and configured to control the receiving of electrical power via connectors(s) 127 when an EV is utilized as an electrical power provider (e.g., via receive controller 144b when an EV is being used as a mobile generator). For example, in a charging mode of operation, electric power controller 144 may be configured to engage the appropriate electronics of dispenser electronics system 130 that provide electrical power from an electrical power provider to an EV via the connector 127 plugged into the EV at the corresponding charging level (e.g., a charging level corresponding to connector 127 connected to the EV, a charging level selected by a user via interface 122, a charging level determined by electric power controller 144 based on information received from the EV such as via communication controller 146, signaling pins of the connectors, etc.). Charging controller 144a may be configured to control the voltage/current levels delivered to the connector 127 connected to the EV to conduct a desired charging event.

Electrical power controller 144 may be further configured to control operation of dispenser electronics system 130 in a mode in which electrical power is received from one or more EVs via connectors(s) 127. For example, electrical power controller 144 may be configured to switch the mode of operation of the hybrid dispenser 1020 from providing electrical power to connectors(s) 127 to perform EV charging to a mode in which electrical power is received from an EV via a connector 127 plugged into an EV (or connected to an EV via a removeable electrical cable), for example, by engaging electrical circuits of dispenser electronics system 130 configured to receive electrical power from one or more EVs via appropriate connector(s) 127. Receive controller 144b may, for example, be configured to control how electrical power received from EVs is converted (if needed or desired), distributed and/or stored, by configuring dispenser electronics system 130 accordingly.

Electrical power controller 144 may be configured to control dispenser electronics system 130 in a dual mode in which electrical power is provided to a first EV via a first connector 127 and received from a second EV via a second connector 127. For example, electrical power controller 144 may configure dispenser electronics system 130 to provide electrical power to the first EV via a first connector 127 connected to the first EV. The second EV may include a PFCEV and electrical power controller 144 may configure control dispenser electronics 130 to receive electrical power from the PFCEV via a second connector 127 connected to the PFCEV. Hydrogen gas controller may control the dispensing of hydrogen gas to a fuel tank of the PFCEV to be converted to electrical power by the PFCEVs fuel cell system. As such, electrical power controller 144 may be configured to control dispenser electronics system 130 to enable hybrid dispenser 1020 to exchange electrical power bi-directionally with EVs 100 in a charging mode, a receive mode or in a dual mode, and may be configured to control operations in conjunction with hydrogen gas controller to perform concurrent, separate or alternating fueling events, charging events and power receive events, examples of which were discussed above in connection with method 500 in FIG. 5 and in further detail below.

Dispenser controller 140 may further include communication controller 146 to facilitate information exchange between hybrid dispenser 1020, vehicles 100 and/or one or more other devices that may be coupled to a network. For example, communication controller 146 may be coupled to one or more communication networks 190 (e.g., a local area network, controller area network, wide area network, the Internet, etc.) to which vehicles 100 are configured to communicate. For example, communication network(s) 190 may include vehicle-to-vehicle and/or vehicle-to-infrastructure communications (referred to as V2X) capabilities (e.g., dedicated short range communications (DSRC)), Wi-Fi, 5G or any other communication capabilities) and communication controller 146 may include one or more transmitters/receivers (transceivers) allowing connection to such communication networks, or may include a connection to one or more external communication devices having the necessary transceiver capabilities.

For example, communication controller 146 may include a roadside unit (RSU) configured to communicate with a vehicle 100's on-board unit (OBUs) to perform V2X communications, or communication controller 146 may include a connection to an RSU external to dispenser 1020 (e.g., a connection to a fueling station's RSU via a local communication network 190 deployed at the fueling station) to receive V2X communications. Communication controller 146 may also be configured to connect to and communicate with the local Wi-Fi network associated with the hybrid dispenser (e.g., an office building or home network) to receive information that dispenser controller 140 may use to initiate a switch between operating modes (e.g., to communicate with smart home or smart building components) either automatically based on power conditions at the hybrid dispenser, under remote control (e.g., via a mobile device), etc.

Communication controller 146 may also be configured to establish one or more direct or one-to-one communication channels with vehicle 100, for example, using one or more short-range communication protocols (e.g., Bluetooth), line-of-sight (LOS) or near-field communication protocols that can be configured to establish communication channels or connections between hybrid dispenser 1020 and vehicles 100 via transmitters/receivers coupled to or integrated in nozzle(s) 125 and/or connector(s) 127 and transmitters/receivers located near a vehicles fueling tank and/or vehicle connectors to establish a connection when the nozzle 125/connector 127 is engaged with the vehicle (e.g., via infrared or radio frequency wireless communication channels), or via direct connections made when nozzle(s) 125/connector(s) 127 are engaged with respective vehicles (e.g., via signaling/communication connections provided on the hybrid dispenser's and vehicle's connectors). Communication controller 146 may be configured to perform any one or combination of V2X techniques described in the '568 publication, including vehicle-to-nozzle pairing, bi-directional exchange of vehicle and dispenser information, etc. Communication controller 146 may also be configured to control charging events and power receiving events based on information exchanged between the electrical connectors on the hybrid dispenser and on an EV's electrical port.

In this way, communication controller 146 may be configured to receive vehicle information that is used to determine the type and capabilities of the vehicle to facilitate refueling and/or recharging the vehicle safely and efficiently, including information needed to perform safety checks before dispensing hydrogen gas for refueling and/or providing electrical power for charging, information used in coordinating operation of hybrid dispenser for dual hydrogen gas fueling and electric charging events, monitoring parameters of the vehicle during a fueling/charging event, etc. As illustrated by the arrows, hydrogen gas controller 142, electrical power controller 144 and communication controller 146 are communicatively coupled to control operations of the hybrid dispenser either by virtue of being part of a single controller or by virtue of being implemented on multiple controllers that are communicatively coupled to each other.

FIG. 10D illustrates a hybrid dispenser 1020 comprising dispenser electronics system 130 implemented in accordance with some embodiments. As discussed above, dispenser electronics system 130 may include power electronics and electrical circuitry that allow electrical power to be exchanged bi-directionally between hybrid dispenser 1020 and EVs. As illustrated in FIG. 10D, dispenser electronics system 130 may include transmit electronics 135a configured to receive electrical power from one or more electrical power providers 1200, perform any power conversion desired/needed and provide electrical power to the one or more connectors 127 in the desired power format (e.g., as AC or DC power at the desired voltage/current levels) for a given EV charging event. Dispenser electronics system 130 may additionally include receive electronics 135b configured to receive power provided by an EV via one or more connectors 127, perform any desired/needed power conversion, and provide electrical power to one or more electrical power receivers 1250 (e.g., any of the electrical power receivers discussed above in connection with FIGS. 5-8, etc.). Transmit electronics 135a and receive electronics 135b may share at least some electrical circuitry (e.g., transmit/receive electronics may share one or more electrical power components such as power converters, amplifiers, ports and/or electrical connections between one or more components of the hybrid dispenser), or may be substantially or entirely separate electronic circuits with their own respective sets of electronic components (e.g., power converters, switch networks, electrical connections, electrical ports, etc.).

Dispenser electronics 130 may include one or more switches that allow transmit electronics 135a and/or receive electronics 135b to be engaged and disengaged, connected/disconnected to and from any shared electrical circuitry and/or otherwise allows transmit electronics 135a to operate in a charging mode, receive electronics 135b to operate in a receive mode, or transmit electronics 135a and receive electronics 135b to operate in a dual charging and receive mode. Control of transmit electronics 135a and receive electronics 135b (e.g., operation of the one or more switches or switch network) may be performed by dispenser controller 140 (e.g., electrical power controller 144 illustrated in FIG. 10C) to control the mode of operation of hybrid dispenser 1020.

For example, in a first mode of operation (e.g., in a charging mode), dispenser controller 140 may configure dispenser electronics system 130 to receive electrical power from one or more electrical energy providers 1200 and provide electrical power to one or more connectors 127 by engaging transmit electronics 135a and configuring the electronics to provide electrical power according to the charging requirements/capabilities of an EV plugged into hybrid dispenser 1020 (i.e., connected to one or more connectors 127). According to some embodiments, dispenser electronics system 130 may be connected or coupled to the local main power infrastructure (e.g., the mains electrical network of a fueling station, building, home, etc.) and transmit electronics 135a may be configured to provide Level 1 and/or Level 2 charging (e.g., single-phase AC charging at household or large appliance voltage/current levels via connection to the mains electricity network). Dispenser electronics system 130 may additionally, or alternatively, be connected to the utility grid providing three-phase AC power (or a mains electrical infrastructure using three-phase power) and transmit electronics 135a may be configured to provide fast DC charging (e.g., Level 3 charging) to an EV plugged into a DC charging-capable connector 127. AC/DC conversion may be performed by dispenser electronics system 130 or by an external power component coupled to dispenser electronics system 130 to provide DC power suitable for DC charging (or that provides DC power that can be converted by dispenser electronics system 130 to perform DC charging) at desired or selected levels (e.g., low, mid or high-current (fast) DC charging).

To facilitate connection to one or more electrical power providers 1200, dispenser electronics system 130 may include an input power port 131a comprising one or more port connectors to which corresponding electrical power providers can connect. For example, input power port 131a may include any one or any combination of a single-phase AC connector, three-phase AC connector, DC connector (or multiple of any of these connectors), etc. Transmit electronics 135a may be configured to receive power through input power port 131a via the one or more connectors and perform any power conversion desired/needed to deliver electrical power to appropriate connector(s) 127 according to a desired type or level of charging. Dispenser controller 140 may configure transmit electronics 135 to receive power via a corresponding port connector at port 131a for hybrid dispenser implementations that are configured to receive power from different electrical power providers 1200 (e.g., via a switch network coupled to the internal side of port 131a). Electrical power providers may include any one or combination of the utility grid, a mains electrical network, an external utility box or power cabinet connected to the utility grid comprising power converters configured to convert grid power into different types of electrical power (e.g., single-phase AC power, DC power at one or more levels), one or more renewable electrical power providers, one or more UPS devices (e.g., one or more electrical storage devices) and/or a power distribution system (e.g., a power distribution system as discussed in further detail below).

According to some embodiments, in a second mode of operation (e.g., a receive mode or a dual mode), dispenser electronics system 130 may be configured to receive electrical power from an EV via an electrical connector 127 connected to the EV by engaging receive electronics 135a to receive electrical power from the connector (e.g., via a connector 127 coupled to a respective electrical cable of the hybrid dispenser or via an electrical connector 127 on the dispenser housing to which a removeable electrical cable has been plugged into). For example, receive electronics 135b may be configured to receive electrical power from EVs via the one or more connectors 127 and provide the electrical power to one or more electrical power receivers 1250. Receive electronics 135b may include one or more power converters to convert electrical power received via connector(s) 127 or may provide electrical power substantially without conversion. As discussed above, to implement bi-directional power exchange with EVs, hybrid dispenser 1020 may include one or more bi-directional connectors 127 and/or or one or more connectors 127 that are dedicated for either delivering or receiving power, respectively. As such, transmit electronics 135a and received electronics 135b may be coupled to one or more of the same connectors 127 (e.g., one or more bi-directional connectors 127) or may be coupled to different connectors 127 (e.g., one or more connectors 127 dedicated to either provide or receive electrical power). In the case of bi-directional connector(s) 127, transmit electronics 135a and receive electronics 135b may share at least some of the electrical circuitry that couples the dispenser electronics system 130 to the bi-directional connector 127 and dispenser controller 140 may configure dispenser electronics system 130 to connect transmit electronics 135a and receive electronics 135b to shared circuitry depending on the mode of operation, which connector(s) 127 are connected to one or more EVs and/or the capabilities of the connected EV(s).

To provide electrical power to one or more electrical power receivers 1250, dispenser electronics system 130 may include output power port 131b comprising one or more port connectors to which corresponding electrical power receivers can connect. For example, output power port 131a may include any one or combination of AC connector(s), DC connector(s), etc. Receive electronics 135b may be configured to provide power through output power port 131b via the one or more connectors after performing any power conversion needed to deliver electrical power in the desired format (e.g., AC or DC power at desired voltage/current levels). As discussed above and in further detail below, electrical power receivers 1250 may include any type of component or system, including hybrid dispenser 1020 itself (e.g., dispenser electronics system 130 may be coupled to provide power to any one or combination of power consuming components of the hybrid dispenser, including dispenser controller 140, interface 122, controls for valves 123, sensor(s) 124, compressors, electrolyzer units, etc.), one or more other dispensers, one or more electrical energy storage devices (e.g., a UPS or battery stack), hydrogen cooling systems, pumps or other equipment, one or more electrical networks (e.g., the local electrical infrastructure, the utility grid, etc.), a power distribution system connected to one or more electrical power receivers 1250, etc.

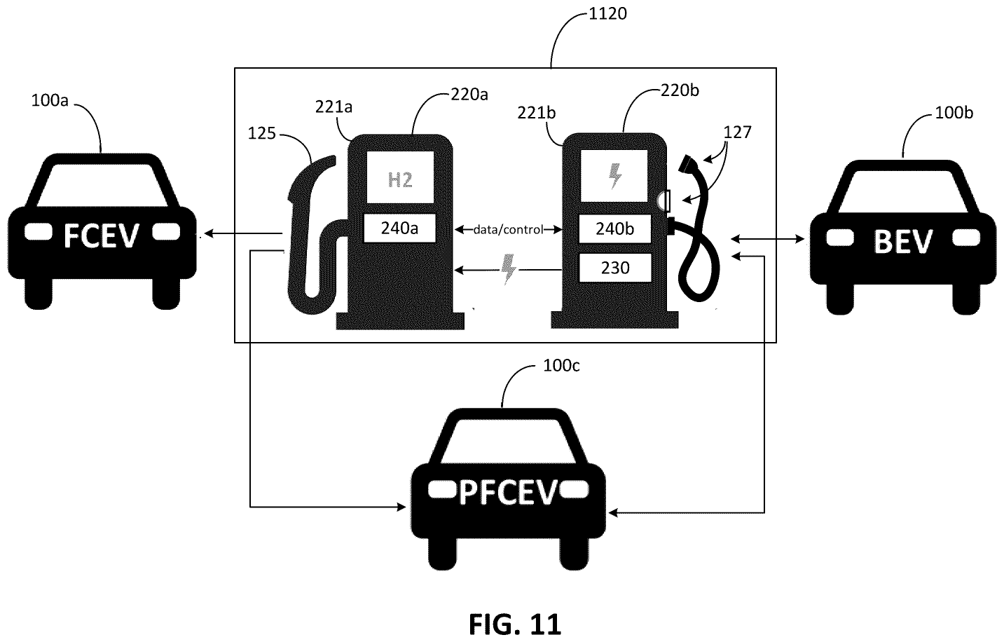

Input power port 131a and output power port 131b may be implemented in any suitable way, for example, as a single power port 131 or as separate power ports. For example, the input/output ports may be implemented as part of an electrical backplane of dispenser electronic system 130 having a plurality of connectors or may be implemented as part of separate electrical backplanes. Furthermore, connectors of input/output power port(s) may be externally accessible (e.g., via the dispenser housing), internally accessible (e.g., via cable passthroughs in the housing, subterranean cables, etc.), internal connectors, or a combination of both internal and external connections. It should be appreciated that the dispenser electronics system 130 illustrated in FIG. 10D shows one exemplary implementation, but dispenser electronics system 130 may be implemented in any suitable way to allow hybrid dispenser 1020 to bi-directionally exchange power with EVs 100 and to both receive power from one or more electrical power providers 1200 and provide power to one or more electrical power receivers 1250. Additionally, while the above-described components of the exemplary hybrid dispenser 1020 illustrated in FIGS. 4A-C and 10A-10D are shown as integrated substantially in housing 121 to which both hydrogen gas nozzle(s) 125 and connectors 127 are coupled, components of a hybrid dispenser may be distributed among multiple housings, an exemplary embodiment of which is illustrated in FIG. 11.

In the exemplary embodiment illustrated in FIG. 11, hybrid dispenser 1120 comprises a hydrogen gas dispenser unit 220a and an electric charging unit 120b having respective housings 221a and 221b. According to some embodiments, hybrid dispenser 1120 may leverage some aspects of existing hydrogen gas dispenser and charging station architectures or deployments for refueling and recharging EVs that may be adapted to operate in concert to utilize PFCEVs as an electrical power source in the manner discussed above and in further detail below. However, hybrid dispenser 1120 need not use any existing hybrid dispenser or charging station architectures/deployments or aspects thereof. In hybrid dispenser 1120, charging unit 221b may comprise power electronics system 230 configured to bi-directionally exchange power with EVs (e.g., BEV 100b and PFCEV 100c) via one or more connectors 127 coupled to housing 221b (e.g., via an electrical cable or provided on housing 221b for connection to one or more removeable electrical cables in any of the configurations described above) and to exchange electrical power with one or more electrical power providers/receivers in the manner described above in connection with dispenser electronics system 130.

Power electronics system 230 may be coupled to the power electronics of hydrogen dispenser unit 220a to provide power to hydrogen dispenser unit 220a in a receive mode or dual mode. For example, hydrogen dispenser unit 220a may be one of the electrical power receivers 1250 that can be provided with electrical power from power electronics system 230 (e.g., from power electronics system 230's receive electronics) received from one or more EVs in a receive mode or dual mode operation. According to some embodiments, power electronics system 230 may be configured to also provide electrical power to the power electronics of hydrogen dispenser unit 220a to power the hydrogen dispenser unit 220a during normal operation (e.g., hydrogen dispenser unit 220a may be powered by power electronics system 230's transmit electronics receiving electrical power from one or more electrical power providers 1200 a first mode). In this way, hydrogen dispenser unit 220a need not have separate connection(s) to electrical power provider(s) 1200. However, according to some embodiments, hydrogen dispenser unit 220a may also include separate connection(s) to one or more electrical power providers 1200 (e.g., via an electrical port with external and/or internal connectors) and independent power electronics to distribute electrical power to components hydrogen dispenser unit 220a.

Hybrid dispenser 1120's dispenser controller may be distributed across controllers within housings 221a and 221b that are communicatively coupled to perform operations of hybrid dispenser 1120. For example, electrical charging unit 220b may include an electrical power controller 240b that implements any of the charging mode, receive mode and/or dual mode control functionality described above for hybrid dispenser controller 140 (e.g., functionality described in connection with electrical power controller 144 described in connection with FIG. 10C). Hydrogen gas dispenser unit 220a may comprise a hydrogen dispenser controller 240a configured to provide control functionality for hydrogen gas dispensing described above for hybrid dispenser controller 140 (e.g., functionality described in connection hydrogen gas controller 142 described in connection with FIG. 10C).

Hydrogen dispenser controller 240a and electrical power controller 240b may be coupled to exchange data and control information to coordinate operations during dual refueling and charging events, during receive mode or dual mode operation and/or during any other operation of hybrid dispenser unit 220a or electric charging unit 220b. Controllers 240a and 240b may be coupled via respective communication controllers that communicate via a communication network (e.g., a communication network 109) and/or may include one or more dedicated communication connections or channels to exchange data and control information between hydrogen gas dispenser unit 220a and charging unit 220b.

The inventors have recognized that the ability to utilize hydrogen gas and electrical power as complimentary energy sources facilitates the ability to implement resilient energy storage systems comprising a plurality of electrical power providers and electrical power receivers and one or more hydrogen gas providers and hydrogen gas receivers coupled via an electrical distribution system comprising a common electrical power bus and a plurality of power converters configured to distribute electrical power between the electrical power providers and electrical power receivers. According to some embodiments, at least one electrical power receiver can also operate as an electrical power provider and at least one electrical power provider comprises a fuel cell system configured to convert hydrogen gas to electrical power that can be provided to the electrical power distribution system. According to some embodiments, the at least one electrical power receiver that can also operate as an electrical power provider comprises a fuel cell system configured to convert hydrogen gas to electrical power (e.g., a PFCEV).

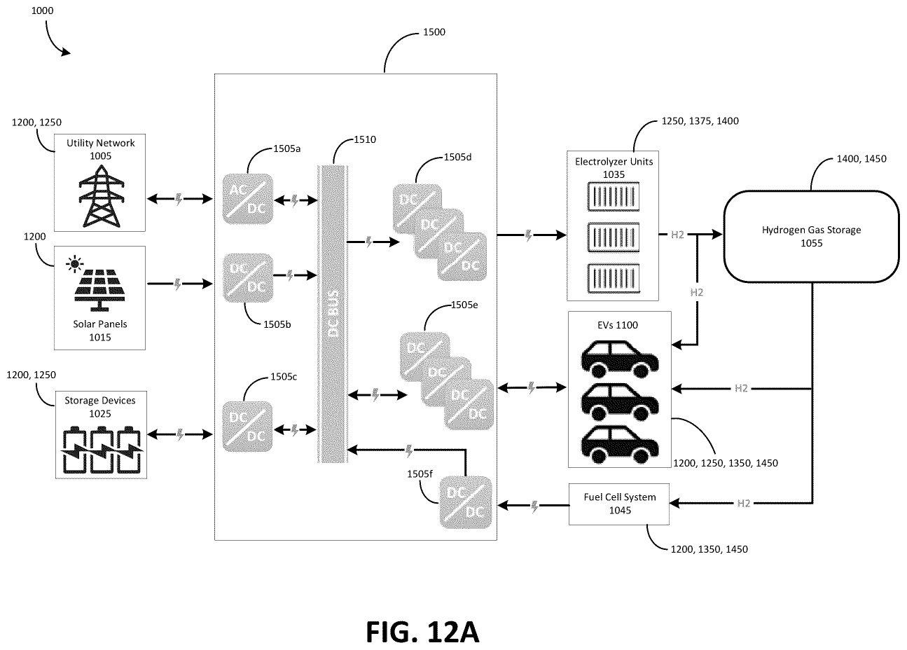

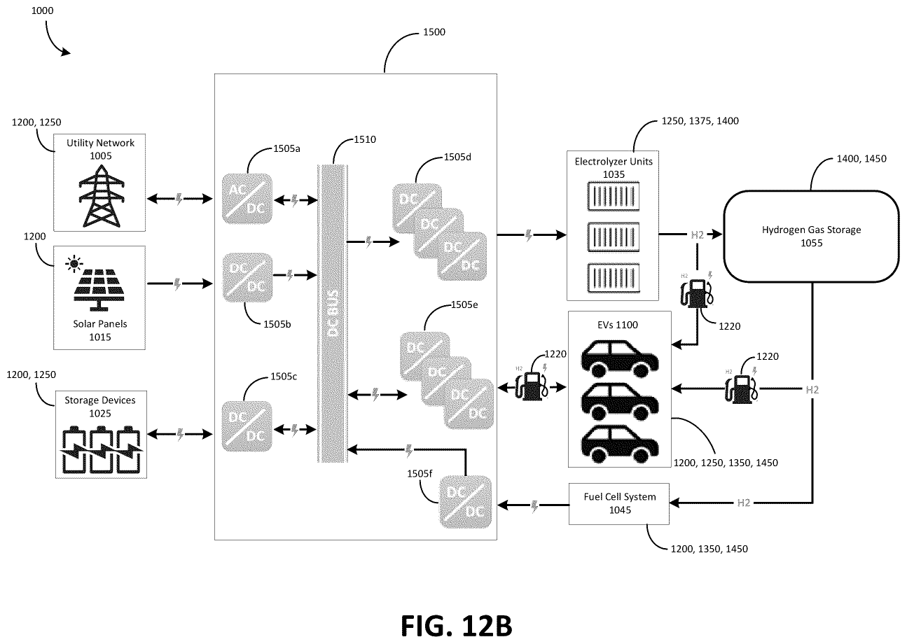

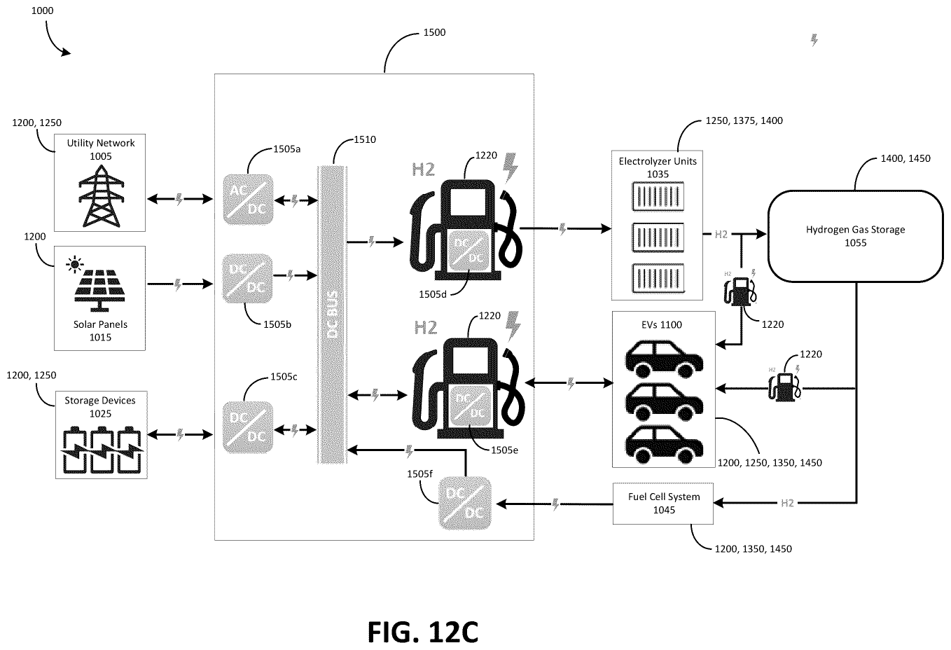

FIG. 12A illustrates a system 1000, in accordance with some embodiments. Exemplary energy storage system 1000 comprises a plurality of electrical power providers 1200, a plurality of electrical power receivers 1250 and a power distribution system 1500 configured to distribute electrical power between the electrical energy providers and electrical energy receivers via a plurality of power converters 1505 coupled to a common electrical bus 1510 (“DC BUS”). The plurality of power converters 1505 may include one or more power converters 1505 coupled to electrical power provider(s) 1200 and/or electrical power receiver(s) 1250, one or more power converters that are part of electrical power provider(s) 1200 and/or electrical power receiver(s) 1250, or a combination of both. That is, power converters 1505 are depicted in FIG. 12A generally to illustrate exemplary power distribution system configurations suitable for distributing electrical power between electrical power provider(s) 1200 and/or electrical power receiver(s) 1250, wherein power converters 1505 may be implemented in any suitable way and as part of any electronics component, including within one or more electrical power utility boxes, as part of one or more electrical power providers/receivers (e.g., as part of a hybrid dispenser), or in any combination thereof.

Exemplary power distribution system 1500 may include one or more AC/DC converters (e.g., AC/DC converter(s) 1505a), one or more DC/AC converters (e.g., DC/AC converter(s) 1505a), and one or more DC/DC converters (e.g., one or more of DC/DC converters 1505b-1505e). As discussed in further detail below, power converters 1505 include one or more power converters that convert electrical power received from the one or more electrical energy providers 1200 to electrical power suitable for distribution over common bus 1510 (e.g., receiving power converters, such as power converters 1505a-1505c, 1505e and 15050, and one or more power converters that convert electrical power distributed by common bus 1510 to electrical power as needed by the respective energy receivers (e.g., distribution power converters, such as power converters 1505a, 1505c, 1505d and 1505e). Power converters 1505 configured to couple with components that can operate as both electrical power providers 1200 and electrical power receivers 1250 may include both receiving power converters and distribution power converters (e.g., power converters 1505a, 1505c and 1505e) to convert electrical power to and from common bus 1510 according to the electrical power requirements of the electrical power providers/receivers to which they are coupled.

Power distribution system 1500 may be coupled to one or more hydrogen gas providers 1400 and one or more hydrogen gas receivers 1450. According to some embodiments, at least one hydrogen gas receiver comprises a hydrogen gas converter 1350 configured to convert hydrogen gas to electrical power (e.g., at least one component that can operate as both a hydrogen gas receiver and an electrical energy provider, such as the fuel cell system of a PFCEV 1100 or standalone fuel cell system 1045 illustrated in FIG. 12A). Additionally, power distribution system 1500 may be coupled to one or more electrical power converters 1375 configured to convert electrical power into hydrogen gas (e.g., electrolyzer unit(s) 1035 illustrated in FIG. 12A).

In system 1000, one exemplary electrical energy provider 1200 coupled to power distribution system 1500 includes utility network 1005, which may include the utility grid and/or one or more secondary electrical networks (e.g., a facility's mains electrical power network). During a first mode of operation, power distribution system 1500 may be configured to receive AC electrical power from utility network 1005, convert the AC electrical power to DC electrical power via power converter(s) 1505a (which include at least one AC/DC power converter), and distribute electrical power to any of the electrical energy receivers 1250 as needed via common DC bus 1510 and corresponding power converters 1505. For example, power distribution system 1500 may distribute at least some electrical power received from utility network 1005 to charge one or more electrical storage devices 1025 (via power converter(s) 1505c), charge one or more EVs 1100 (e.g., including BEVs or PFCEVs via power converters 1505e), provide electrical power to one or more electrolyzer units 1035 (via power converter(s) 1505d), etc.

As discussed above, utility network 1005 may include the electrical power grid and any electrical infrastructure connected thereto (e.g., a mains electrical network or other secondary electrical power network) and power distribution system 1500 may be configured to receive electrical power from the utility network 1005 via a three-phase connection (e.g., a three-phase connection to the grid) or a single-phase connection (e.g., a single-phase connection to the mains electrical network), or both. As such, AC/DC converter(s) 1505a may include one or more AC/DC converters configured to convert three-phase AC power to DC power suitable for common bus 1510, one or more AC/DC converters configured to convert single-phase AC power to DC power suitable for common bus 1510, or both. As such, power distribution system 1500 may be configured to receive and convert electrical power from the grid and/or from one or more secondary networks connected to the grid and distribute that electrical power to one or more electrical energy receivers 1250 connected to power distribution system 1500. Similarly, power converter(s) 1505a may include DC/AC power converters configured to convert DC power provided via common bus 1510 to any of the above discussed AC power formats to deliver electrical power back to utility network 105 during a second mode of operation.

Power distribution system 1500 may additionally be coupled to electrical storage devices 1025 (e.g., UPS devices), which may include any number or type of devices configured to store and provide electrical energy (e.g., one or more electro-chemical batteries such as lithium-ion batteries, capacitive-storage devices, etc.). Power distribution system 1500 may therefore include one or more DC/DC converters 1505c to convert DC electrical power from common bus 1510 to charge electrical storage devices 1025 when one or more electrical storage devices 1025 are operating as electrical power receiver(s) 1250 (e.g., during a first mode of operation in which power distribution system 1500 distributes electrical power received from utility network 1005 to charge one or more electrical storage devices 1025 that are not fully charge) and power distribution system 1500 may include one or more DC/DC power converters 1505c that convert DC power from electrical storage device(s) 1025 to DC power that is distributed by common bus 1510 to one or more electrical energy receivers 1250 as needed when one or more electrical storage devices 1025 operate as electrical power provider(s) 1200.

As examples, electrical storage device (s) 1025 may include one or more electrical storage devices to operate as an auxiliary power source (e.g., as a UPS) in the event of power failure in the primary power source (e.g., utility network 1005), when electrical power from the primary power source is in high demand to decrease the load on the primary power source, when electrical power from the primary source is expensive (e.g., one or more electrical storage devices 1025 may operate as an electrical power receiver 1250 when usage rates at the primary source are low and operate as an electrical power provider 1200 when usage rates at a primary source are high). Electrical storage devices 1025 may include also include electrical storage devices of one or more hydrogen gas dispensers, charging stations and/or hybrid dispensers that are coupled to the power distribution system 1500. Thus, one or more electrical storage device(s) 1025 may operate as an electrical power receiver 1250 and/or as an electrical energy provider 1200 during a first mode of operation, either at different times or simultaneously as the power needs of the electrical storage system 1000 change, and as both an electrical energy receiver 1250 and provider 1200 in a second mode, as discussed in further detail below.

Power distribution system 1500 may additionally be connected to one or more renewable electrical energy sources such as solar panels, wind turbines, etc. For example, distribution system 1500 may be coupled to solar panels 1015 via power converters 1505b, as illustrated in system 1000 of FIG. 12A. Power distribution system 1500 may be configured to receive electrical power from solar panels 1015 and distribute electrical power to one or more electrical energy receivers in a manner similar to that described in connection with utility network 1005. As discussed below, solar panels 1015 (or another renewable energy provider such as wind turbine electrical power) may deliver power during the first mode of operation as well as during a second mode of operation discussed below (e.g., during a resiliency mode when a primary source of electrical power has been disrupted).

In a first mode of operation, power distribution system 1500 may distribute electrical power received from utility network 1005 to charge one or more EVs 1100, which may include BEVs and/or PFCEVs. For example, DC/DC converters 1505e may be coupled to or may be part of one or more charging stations or hybrid dispensers (e.g., as illustrated in FIGS. 12B and 12C, respectively) configured to deliver electrical power to one or more EVs 1100 (e.g., in a charging mode as discussed above). For example, power distribution system 1500 may include a DC/DC converter 1505e for different types of connectors and charging levels to accommodate a wide variety of EVs 1100. DC/DC converters 1505e may also include one or more power converters, which may be coupled to or part of one or more hybrid dispensers or charging stations (e.g., as illustrated in FIGS. 12B and 12C, respectively) configured to convert electrical power received from one or more EVs 1100 to electrical power that can be distributed by common bus 1510 to one or more electrical energy receivers as needed, e.g., during a second mode of operation.

In both a first mode of operation and in a second mode of operation, one or more FCEVs or PFCEVs may receive hydrogen gas from hydrogen gas providers 1400 to refuel vehicle fuel tanks, e.g., via one or more hydrogen gas dispensers and/or hybrid dispensers coupled to (or comprising) one or more hydrogen gas providers 1400. For example, according to some embodiments, power distribution system 1500 may be coupled to one or more electrolyzer units 1035 configured convert electrical power into hydrogen gas to provide electrolyzer units(s) 1035 with electrical power to produce hydrogen gas that can be stored by hydrogen gas storage 1055 (e.g., one or more hydrogen gas tanks) and/or provided to FCEVs or PFCEVs to refuel the vehicle (e.g., via one or more hydrogen gas dispensers or hybrid dispensers), thus on-site production of hydrogen gas. According to some embodiments, one or more electrolyzer unit(s) 1035 may be a component of a hydrogen gas dispenser or hybrid dispenser itself (e.g., housed within the dispenser), for example, like example dispensers disclosed in the '062 patent. According to some embodiments, one or more electrolyzer unit(s) may be units external to the dispensers (e.g., a standalone electrolyzer stack, etc.).

According to some embodiments, power distribution system 1500 may include one or more DC/DC converters 1505d configured to provide electrical power from common bus 1510 to electrolyzer units(s) 1035 or power distribution system 1500 may configured to use one or more DC/DC converters 1505e and include appropriate switching modes to share one or more power converters as appropriate. According to some embodiments, one or more DC/DC converters 1505e are provided in a hybrid dispenser and may be used to both convert electrical power provided to and/or received from EVs 1100 and used to provide electrical power to one or more electrolyzer unit(s) 1035, which may be provided either internal and/or external to the hybrid dispenser, to contribute to on-side production of hydrogen gas. Hydrogen gas storage 1055 may include one or more storage tanks providing on-site hydrogen gas and/or may include one or more transportable/mobile hydrogen gas tanks (e.g., a tube trailer) for use as a transportable/mobile hydrogen gas supply.

In a second mode of operation, one or more electrical energy receivers 1250 may be operated as an electrical energy provider 1200, for example, in response to an event at a primary electrical power source (e.g., utility network 1005), such as a loss of power, a change in demand and/or a change in usage rates. According to some embodiments, power distribution system 1500 is configured to utilize one or more EVs 1100 as an electrical energy provider to distribute electrical power to one or more other electrical energy receivers 1250, including potentially one or more components that operated as an electrical energy provider 1200 during a first mode of operation (e.g., utility network 1005, electrical storage devices 1025, hybrid dispensers, etc.). However, power distribution system 1500 may be configured to distribute electrical power received from one or more EVs 1100 to any suitable electrical energy receiver, as the aspects are not limited in this respect.

As one example, in a second operating mode, one or more power converters 1505e may be configured to receive electrical power from one or more BEVs or PFCEVs, e.g., via a connection made between one or more electric charging stations and/or one or more hybrid dispensers (e.g., any of the hybrid dispensers discussed herein) and, after performing any necessary power conversion, provide the electrical power to common bus 1510 for distribution to one or more other electrical energy receivers 1250. For example, power distribution system 1500 may distribute electrical power from one or more EVs 1000 to provide power to operate one or more hydrogen gas dispensers, hybrid dispensers, charging stations, etc.), to provide power to utility network 1005 (e.g., to provide electrical power to the local electrical infrastructure and/or to provide power back to the grid, etc.), to provide electrical power to one or more electrical storage devices 1025, etc. As with power converters 1505e configured to provide electrical power from power distribution system 1500 to EVs 1100, power converters 1505e configured to provide electrical power from EVs to power distribution system 1500 may be coupled to or be part of one or more hybrid dispensers, as illustrated in FIGS. 12B and 12C.

For example, as illustrated in FIG. 12B, one or more of the electrical connections between power distribution system 1500 and EVs 1100 include a hybrid dispenser 1220, which may include any of the hybrid dispenser configurations described herein. For example, a hybrid dispenser 1220 may be coupled to one or more of power converters 1505e to receive DC electrical power to be delivered to one or more EVs 1100, with or without further conversion by the electronics system of the hybrid dispenser. Additionally, one or more of the hydrogen gas connections between hydrogen gas providers 1400 and EVs 1100 may include a hybrid dispenser 1220 to implement any of the mobile generator techniques described herein. It should be appreciated that one or more of the electrical connections may also include a charging station and one or more of the hydrogen gas connections may include a hydrogen gas dispenser that are not configured to operate as hybrid dispensers. As illustrated in FIG. 12C, one or more of power converters 1505d and/or 1505e may be part of a hybrid dispenser 1220. For example, one or more power converters 1505d/1505e may be part of the power electronics system 130 discussed in connection with FIGS. 10A-10D (e.g., as part of transmit electronics 135a and/or receive electronics 135b discussed in connection with FIG. 10D). As discussed above, one or more electrolyzer units 1035 may be internal to a hybrid dispenser 1220 and electrical power received from common bus 1510 may be provided to an internal electrolyzer unit 1035 by the hybrid dispensers power electronics system to generate hydrogen gas that can be dispensed to vehicles for refueling.

The inventors have recognized that wireless charging technology may be used to implement a hybrid dispenser to replace or supplement conventional “wired” EV charging (e.g., EV charging using a physical electrical connection such an electrical cable or cord connected between an electrical power supply and the EV as discussed above) to facilitate refueling and/or recharging of EVs (e.g., FCEVs, BEVs and PFCEVs, etc.). According to some embodiments, a hybrid dispenser performs EV charging using wireless charging technology configured to wirelessly charge the battery of the vehicle. When an EV includes a fuel cell system (e.g., a PFCEV), wireless charging may be performed while the vehicle is being refueled with hydrogen. According to some embodiments, a hybrid dispenser is configured to perform hydrogen gas fueling events and wireless charging events. According to some embodiments, wireless charging technology is implemented in a bi-directional configuration wherein a hybrid dispenser comprises a wireless charging system configured to both wirelessly charge a battery of an EV and to wirelessly receive electrical power from an EV to utilize the EV as a mobile generator, examples of which are described in further detail below.

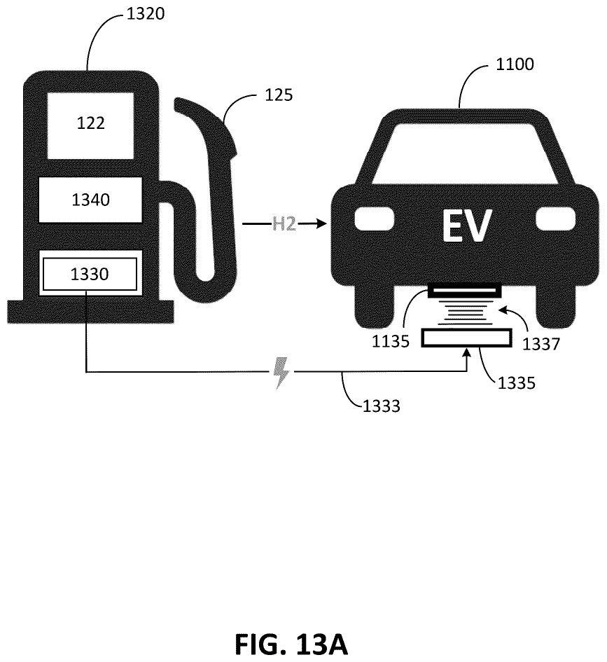

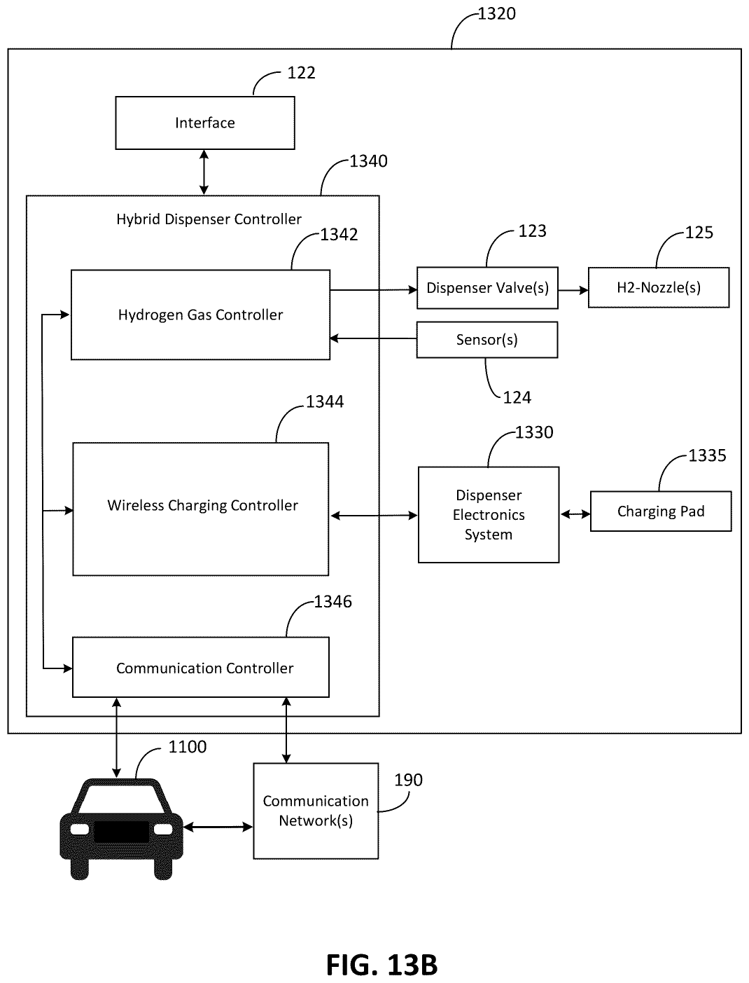

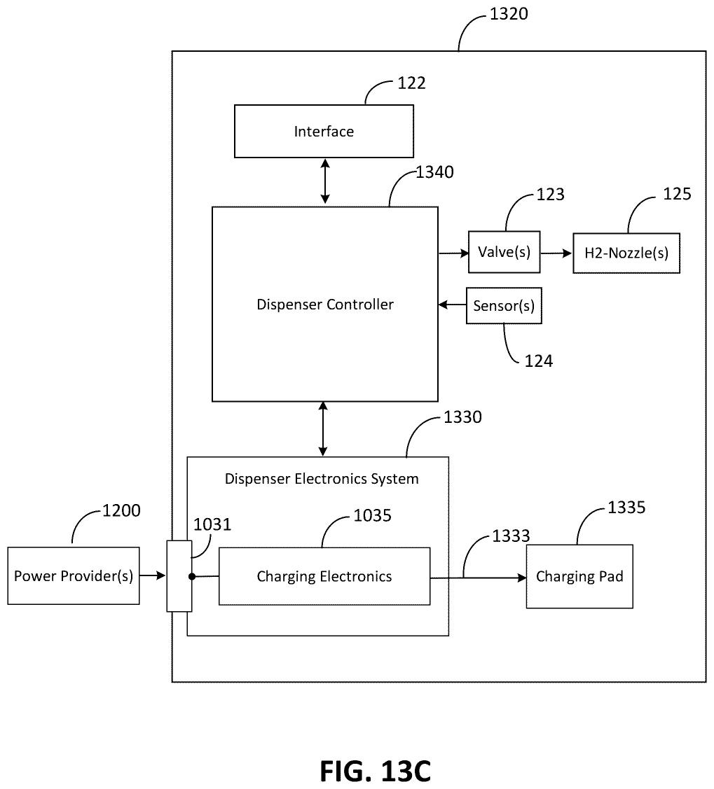

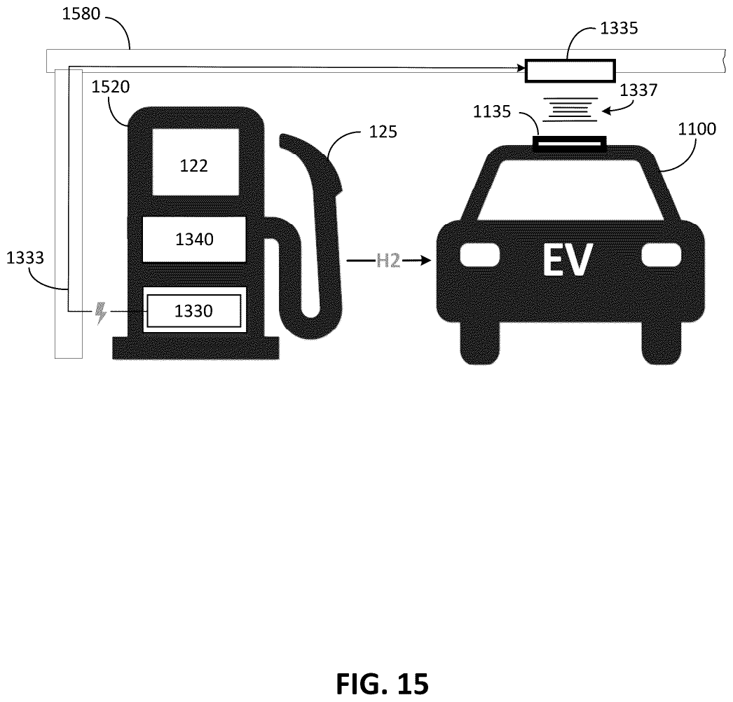

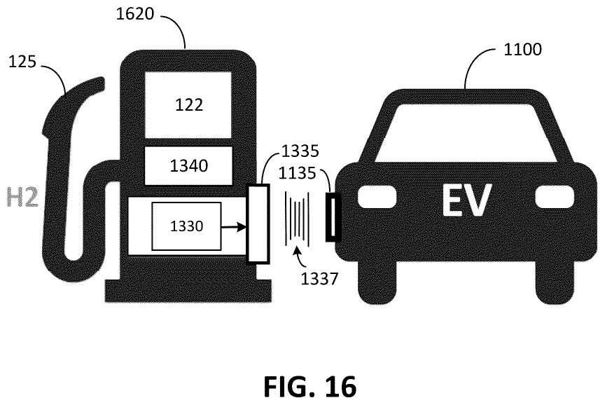

FIG. 13A illustrates a hybrid dispenser 1320 configured to dispense hydrogen gas to FCEVs and PFCEVs such as vehicle 1100 via hydrogen gas nozzle 125 and configured to charge EV batteries (e.g., one of more batteries of a BEV, PFCEV, etc.) using a wireless charging system configured to wirelessly couple to an EV to provide electrical power to charge the EV battery via the wireless coupling. In particular, in addition to one or more hydrogen gas nozzles 125 configured to dispense hydrogen gas to the fuel tank of EV 1100, hybrid dispenser 1320 comprises power supply 1330 connected to a wireless charging pad 1335 via an electrical connection 1333. EV 1100 comprises a charging unit 1135 coupled to one or more batteries of the vehicle and configured to electromagnetically couple to charging pad 1335 when charging pad 1335 is provided with electrical power from power source 1330. In FIG. 13A, charging unit 1135 is located or positioned on the underside of vehicle 1100 so as to readily couple with the charging pad 1335 when EV 1100 has stopped or is parked in proximity to hybrid dispenser 1320 and charging pad 1335 is operated (e.g., provided with electrical power). However, the charging pad 1335 and charging unit 1135 may be provided in other configurations (e.g., the exemplary configuration illustrated in FIGS. 15 and 16), as the aspects are not limited in this respect.

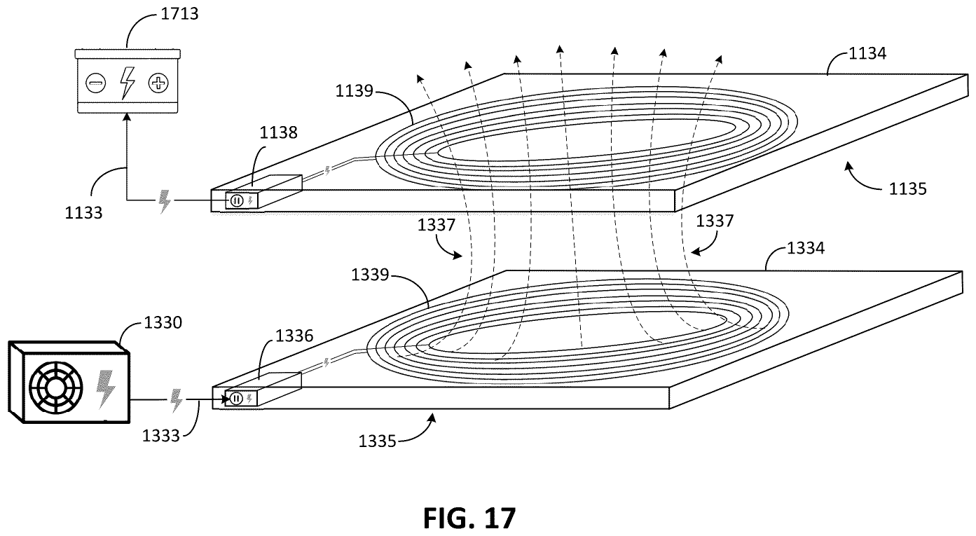

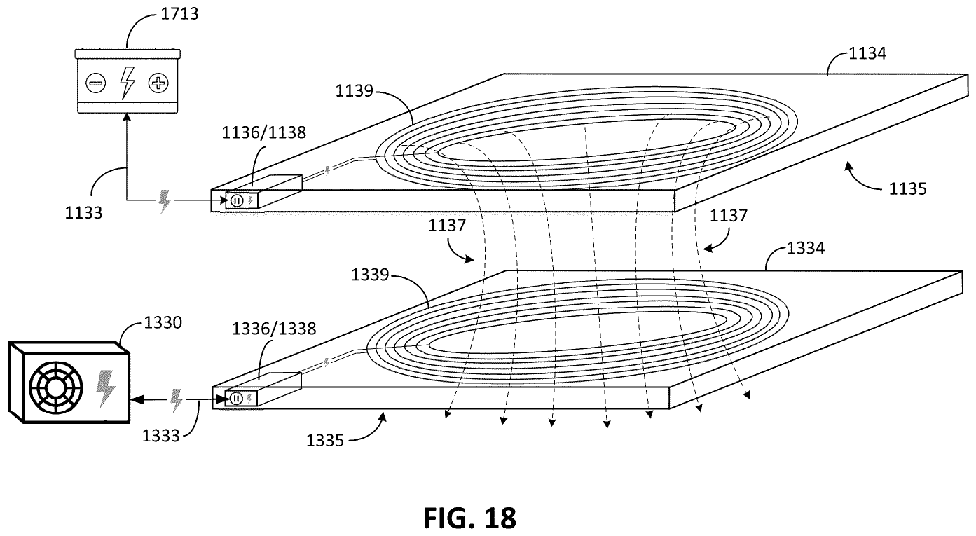

Exemplary charging pad 1335 is configured to receive electrical power from power source 1330 and use the electrical power to produce electromagnetic energy. For example, power source 1330 may provide AC or DC electrical power to charging pad 1335 (i.e., depending on the design of charging pad 1335) via electrical connection 1333. Charging pad 1335 may be configured to convert received electrical power into an electrical current that is used to produce an electromagnetic field that is radiated out from charging pad 1335, illustrated as electromagnetic field 1337. According to some embodiments, charging pad 1335 includes one or more coils (e.g., as illustrated in FIGS. 17 and 18 discussed below) configured to produce an electromagnetic field 1337 when electrical current received or derived from the electrical power from power source 1330 is provided to the one or more coils. When charging unit 1135 is positioned in proximity to charging pad 1335, charging unit 1135 couples to electromagnetic field 1337 and converts energy from electromagnetic field 1337 into electrical current. For example, charging unit 1135 may include one or more coils (e.g., as also illustrated in FIGS. 17 and 18 discussed below) through which electromagnetic field 1337 induces electrical current. The induced electrical current (or an electrical current derived therefrom) may then be provided to the one or more batteries of vehicle 1100 for charging. Thus, hybrid dispenser 1320 can perform a fueling event via nozzle(s) 125 and a charging event via a wireless charging system (e.g., via a wireless charger comprising power source 1330, electrical connection 1333 and charging pad 1335.)

Power source 1330 may be any suitable electrical component or components capable of providing electrical power that can be used by charging pad 1335 to generate an electromagnetic filed for wirelessly coupling to an EV's charging unit 1135. For example, power source 1330 may be implemented within the power electronics system of hybrid dispenser 1320 (e.g., power electronics system 130 discussed in connection with FIGS. 10A-10D). In particular, power source 1330 may be, or may include, the power electronics pathway between one or more electrical power providers 1200 and charging pad 1335. For example, power source 1330 may be implemented, at least in part, like transmit electronics 135a discussed in connection with FIG. 10D, but may be configured to provide power from one or more electrical power providers 1220 to electrical connection 1333. That is, power source 1330 may include the electronic circuits configured to receive electrical power from one or more electrical power providers 1200, perform any desired/needed power conversion and provide electrical power to charging pad 1335 via electrical connection 1333. According to some embodiments, power source 1330 may be external or partially external to hybrid dispenser 1320, as the aspects are not limited to any particular configuration and/or implementation.

According to some embodiments, portions of the wireless charging system may be provided beneath or partially beneath the surface of a dispenser platform or ground surface. For example, according to some embodiments, electrical connection 1333 is provided underneath the surface on which vehicles travel (e.g., beneath the dispenser or fueling station platform), such as via a subterranean cable, cord, wire bundle, etc. However, electrical connection 1333 can be any connection, either above or below ground, that is capable of providing electrical power from power source 1330 to operate charging pad 1335 (e.g., as illustrated by the exemplary configurations illustrated in FIGS. 15 and 16). Charging pad 1335 may also be positioned below ground, partially below ground or entirely above ground. For example, charging pad 1335 may be partially beneath the ground surface with an upper surface above ground or at the ground surface. The upper surface or portions above ground may be protected (e.g., positioned with a housing, provided with a protective shielding or coating) to prevent damage from vehicles and/or the elements. Alternatively, charging pad 1335 may be positioned entirely beneath or above the surface, as the aspects are not limited in this respect.

Hybrid dispenser 1320 may include a hybrid dispenser controller 1340 to control hydrogen refueling and wireless electric charging. For example, hybrid dispenser controller may include one or more controllers configured to perform any of the functionality of hybrid dispenser controller 140 discussed above in connection with FIGS. 10A-10D pertaining to hydrogen gas dispensing and communication. Hybrid dispenser controller 1340 may further include one or more controllers configured to control a wireless charging event, for example, by controlling power source 1330 to provide power to charging pad 1335 to generate an electromagnetic field to wirelessly couple to charging unit 1135 of vehicle 1100.

For example, FIG. 13B illustrates a hybrid dispenser 1320 having a hybrid dispenser controller 1340 implemented in accordance with some embodiments. In the embodiment illustrated in FIG. 13B, hybrid dispenser controller 1340 comprises a hydrogen gas dispenser controller 1342 that may be configured to perform any of the functionality of hydrogen gas controller 142 described in connection with FIG. 10C and communication controller 1346 that may be configured to perform any of the functionality of communication controller 146 described in connection with FIG. 10C. In the exemplary embodiment illustrated in FIG. 13B, power source 1330 is implemented, at least in part, by the hybrid dispenser's power electronics system 1330 and hybrid dispenser controller 1340 comprises wireless charging controller configured to control dispenser electronics system 1330 to provide power to charging pad 1335 during a wireless charging event. For example, wireless charging controller 1344 may control the engaging or activation of the power electronics circuitry that receives electrical power from one or more electrical power providers 1200, performs any desired/needed power conversion, and provides electrical power to operate charging pad 1335, as illustrated in FIG. 13C. For example, the exemplary dispenser electronics system 1330 illustrated in FIG. 13C comprises charging electronics 1035 coupled to receive electrical power form one or more electrical power providers 1200 (e.g., via a power port 131 having one or more connectors), perform any power conversion desired/needed to deliver electrical power to charging pad 1335 via electrical connection 1333 to operate charging pad 1335 to produce electromagnetic energy that can be used to inductively charge an EV configured with a corresponding charging unit 1135.

As discussed above in connection with hybrid dispenser controller 140, hybrid dispenser controller 1340 may be a single controller or multiple controllers that are communicatively coupled together. In particular, exemplary hydrogen gas controller 1342, wireless charging controller 1344 and communication controller 1346 illustrated in FIG. 13B represent control functionality that may be implemented on one physical controller or multiple physical controllers that are coupled to communicate (e.g., exchange data, control information, signaling) to coordinate operations of the hybrid dispenser. Like hybrid dispenser controller 140, the one or multiple controllers forming dispenser controller 1340 (and any controllers described herein) may be implemented as one or any combination of one or more processors, microcontrollers, ASICS, FPGAs, etc., or any other suitable software and/or hardware controllers, as the aspects are not limited for use with any particular dispenser controller configuration or implementation. Moreover, dispenser electronics system 1330 may include any of the electronics needed to provide power to components of the hybrid dispenser to perform a hydrogen fueling event, a wireless charging event, or both (e.g., dispenser electronics system may include the electrical circuitry needed to power interface 122, valve(s) 123, sensor(s) 124 illustrated in FIG. 13B, or to operate other components that may be part of a particular hybrid dispenser implementation (e.g., compressors, electrolyzer units, etc.).

Accordingly, hybrid dispenser 1320 is capable of refueling FCEVs, wirelessly charging BEVs and/or concurrently refueling and wirelessly charging PFCEVs. According to some embodiments, when an EV 1100 arrives at hybrid dispenser 1320, hybrid dispenser 1320 may determine whether the EV is a BEV only, an FCEV only or a PFCEV and whether EV 1100 is capable of wireless charging. For example, hybrid dispenser 1320 may determine the type of the EV using any of the V2X communication techniques above and/or described in the incorporated '568 publication. Alternatively, hybrid dispenser 1320 may determine the type of the EV and/or whether the EV is capable of wireless charging by virtue of a user providing information to the hybrid dispenser via interface 122. Once hybrid dispenser 1320 has determined the type of vehicle, the system may commence with a hydrogen refueling event, wireless charging event, or both. Dispenser controller 1340 may transition through various checks (e.g., safety check for combustible gas, ambient temperature checks, cooling system check if hydrogen pre-cooling is used, and checks for proper functioning of the wireless charging system if wireless charging is to be performed) prior to initiating hydrogen gas refueling and/or wireless charging. Hybrid dispenser controller 1340 may be configured to control the components of the hybrid dispenser needed to perform refueling events, wireless charging events or coordinate operations for dual hydrogen fueling and wireless charging events. According to some embodiments, dispenser controller 1340 may be configured to operate charging pad 1335 without determining whether a vehicle is capable of wireless charging (e.g., by continuously operating charging pad 1335 during some predetermined time-period, operating charging pad 1335 whenever a vehicle is detected proximate the hybrid dispenser, whenever a vehicle engages with a hydrogen nozzle, etc.). In this way, hybrid dispenser 1320 can be configured to operate charging pad 1335 without determining whether the vehicle can make use of the hybrid dispenser's wireless charging capabilities (or alternatively, even whether or not a vehicle is present).

According to some embodiments, hybrid dispenser 1320 may be configured to operate charging pad 1335 whenever a vehicle is detected proximate the dispenser and the charging pad 1335 may be configured to detect whether a cooperating charging unit 1135 of the vehicle has coupled to the charging pad 1335 or, alternatively, the vehicle's charging unit 1135 may signal that a wireless coupling has been made, either wirelessly to the charging pad 1335 or via any other communication channel established between the EV and the hybrid dispenser. According to some embodiments, if no wireless coupling is detected, hybrid dispenser may be configured to cease operation of charging pad 1335. If a wireless coupling is detected, hybrid dispenser may proceed with a charging event or may present the option of wireless charging to the vehicle's operator (e.g., via interface 122) and only proceed with a charging event if requested. It should be appreciated that hybrid dispenser 1320 may be configured to initiate and perform a charging event in any suitable way, as the aspects are not limited in this respect.

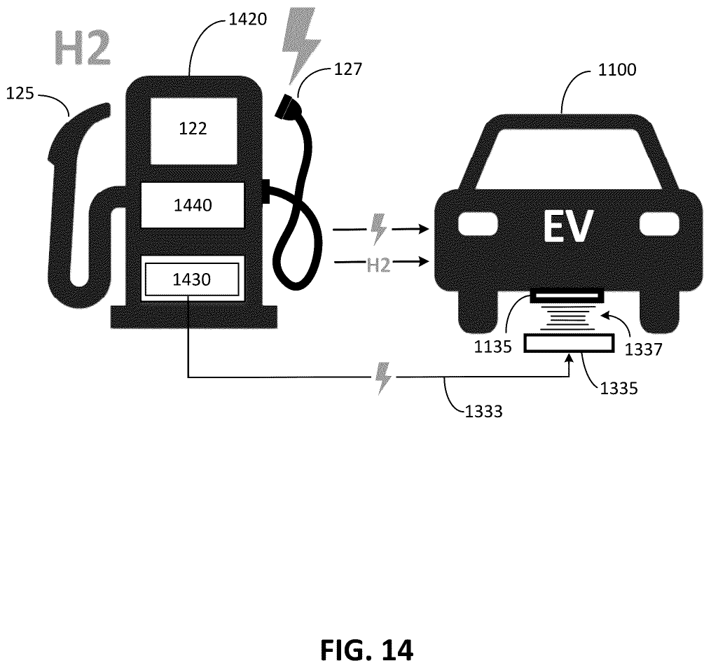

According to some embodiments, a hybrid dispenser may also include one or more connectors for plug-in charging (e.g., one or more connectors 127 described for the hybrid dispensers and charging stations discussed above), as illustrated in FIG. 14. For example, exemplary hybrid dispenser 1420 comprises one or more hydrogen gas nozzles 125, one or more electrical connectors 127 for plug-in charging and a wireless charging system as described above in connection with exemplary hybrid dispenser 1320 illustrated in FIGS. 13A-13C. Hybrid dispenser 1420 may therefore be used to simultaneously perform, hydrogen refueling, wireless charging and plug-in charging, and/or to perform any one of hydrogen refueling, wireless charging and plug-in charging alone and/or independently, as the aspects are not limited in this respect.

FIG. 15 illustrates a hybrid dispenser 1520 in which the wireless charging system is arranged in a different configuration. Specifically, in the configuration illustrated in FIG. 15, charging pad 1335 is affixed to canopy 1580. For example, fueling stations often include canopies to shield against the elements. Such canopies are frequently already wired for electricity to provide nighttime lighting, etc. (e.g., a canopy may be connected to the local electrical infrastructure of the fueling stations). Charging pad 1335 may be affixed, attached or otherwise built into canopy and connected to the electrical network of the fueling station, which may include power source 1330 or to which power source 1330 may be coupled. Charging unit 1135 may be positioned on a top portion of vehicle 1100, for example, the roof, hood or other location suitable for coupling with electromagnetic field 1337 generated by charging pad 1335. FIG. 16 illustrates another configuration for the wireless charging system in which charging pad 1335 is disposed on or integrated within hybrid dispenser 1620 and charging unit 1135 is positioned on the side of the vehicle such that charging pad 1135 is capable of coupling with electromagnetic field 1337 when vehicle 1100 drives up next to or sufficiently proximate hybrid dispenser 1620. It should be appreciated that the configurations illustrated for the wireless charging systems illustrated in FIGS. 13-16 are merely exemplary and any other configuration that allows charging pad 1335 and charging unit 1135 to electromagnetically couple may be used, as the aspects are not limited in this respect. Additionally, any of the hybrid dispensers capable of wireless charging may also include one or more connectors for plug-in charging (e.g., as shown for exemplary hybrid dispenser 1420 illustrated in FIG. 14). That is, a hybrid dispenser may include both wireless and plug-in charging capabilities for any configuration of the wireless charging system.

FIG. 17 illustrates schematically an exemplary charging pad 1335 and charging unit 1135 for use in wireless charging of EVs, for example, in any of the wireless charging configurations illustrated in FIGS. 13-16. In particular, exemplary charging pad 1335 illustrated in FIG. 17 may include a housing 1334 for a conductive coil 1339 (or multiple conductive coils 1339) electrically coupled to transmit electronics 1336. Conductive coil(s) 1339 may be formed by a conductive coil of wire (e.g., a copper wire coil), a conductive coil formed by conductive traces on a printed circuit board, a coil formed by machining sheets of conductive material, or any other suitable electromagnetic coil implementation. Transmit electronics 1336 may include an electrical port having one or more connectors to allow for an electrical connection 1333 to be made between charging pad 1335 and a power source 1330 (illustrated schematically as power supply 1330 in FIG. 17), which may be the power electronics system of the hybrid dispenser as described above. Transmit electronics 1336 may include any electronic components and circuitry (e.g., power converters, amplifiers, etc.) needed to convert the electrical power received from power source 1330 to an electrical current suitable for driving the one or more coils 1339.

Exemplary charging unit 1135 also comprises a housing 1134 for one or more conductive coils 1139 electrically coupled to receive electronics 1138. Conductive coil(s) 1139 may likewise comprise wire coils, coils formed by printed conductive traces, conductive sheet coils, etc., or any other suitable electromagnetic coil implementation. Receive electronics 1138 may include an electrical port having one or more connectors configured to provide an electrical connection 1133 to an EV battery, illustrated schematically as battery 1713, to provide electrical power to charge battery 1713 (e.g., via the charging electronics system or electrical distribution network of the EV's power system). Receive electronics 1138 may include any electronic components/circuitry needed to convert electrical current induced in coil(s) 1139 to electrical power that can be provided to charge battery 1713.

In operation, electrical power provided by power source 1330 is received by transmit electronics 1336 via the electrical port to which electrical connection 1333 is connected. Transmit electronics 1336 may perform any needed power conversion to provide an electrical current to energize coil(s) 1339 to produce an electromagnetic field. That is, current flow in coil(s) 1339 produce an electromagnetic field, shown as electromagnetic field lines 1337. It should be appreciated that electromagnetic field lines 1337 are merely schematic to illustrate the principle by which energized coil(s) 1339 induce a current in conductive coil(s) 1139. Specifically, the electromagnetic field produced by coil(s) 1339 when energized with electrical current induce current in coil(s) 1139 that is received by receive electronics 1138 via the electrical coupling with coil(s) 1139. Receive electronics 1138 in turn may perform any desired/needed power conversion of the induced current received from coil(s) 1139 to electrical power suitable for charging battery 1713. In this way, power source 1330 can inductively charge battery 1713, for example, in any of the configurations described in connection with the hybrid dispensers illustrated in FIGS. 13-16.

The inventors recognized that by configuring charging pads/charging units with appropriate transmit and receive electronics, the above-described operation can be reversed, as illustrated in FIG. 18. That is, the principle of driving one coil to induce current in another coil can be employed to exchange power bi-directionally. For example, charging unit 1135 in FIG. 18 may be implemented with both transmit and receive electronics 1136/1138 configured to convert electrical power received from battery 1713 to an electrical current provided to drive coil(s) 1139 to produce an electromagnetic field (via transmit electronics 1136) and to convert induced current received from coil(s) 1139 to electrical power to charge battery 1713 (via receive electronics 1138 as discussed in connection with FIG. 17). Similarly, charging pad 1335 may be implemented with transmit and receive electronics 1336/1338 configured to convert electrical power received from power component 1330 to an electrical current to drive coil(s) 1339 to produce an electromagnetic field (via transmit electronics 1336 as discussed in connection with FIG. 17) and to convert induced current received from coil(s) 1339 to electrical power provided to power component 1330 (via receive electronics 1338).

Thus, each of charging unit 1135 and charging pad 1335 can be operated as an electrical energy provider and as an electrical energy receiver (e.g., by operating the respective transmit/receive electronics accordingly). In FIG. 18, charging unit 1135 is shown operating as an electrical provider and charging pad 1335 is shown operating as an electrical receiver (i.e., opposite to the operation illustrated in FIG. 17). Thus, electrical power stored in battery 1713 can be provided to transmit electronics 1136 to energize coil(s) 1139 to produce an electromagnetic field, illustrated schematically as electromagnetic field lines 1137. The electromagnetic field generated by coil(s) 1139 induces a current in coil(s) 1339 that is received by receive electronic 1338 and converted to electrical power that is provided to power component 1330. In this way, wirelessly charging technology can be employed to provide bi-directional electrical power exchange with an EV, thus providing an alternative or additional channel by which EVs can be utilized as mobile generators in any of the systems described above, either alone or in combination with plug-in electrical power exchange.

According to some embodiments in which wireless charging components are bi-direction, bi-direction electrical connection 1333 may be implemented as electrical connection(s) that convey electrical power in either direction, as multiple electrical connections dedicated to conveying electrical power in a single direction (e.g., transmit electrical connection(s) for transmitting electrical power to charging pad 1335 and separate receive electrical connections(s) for receiving electrical power from charging pad 1335), or in any other way suitable way for providing a bi-directional electrical power channel. Additionally, a bi-directional charging unit may be configured to receive electrical power from the vehicle's fuel cell system to be provided wirelessly to a bi-directional charging pad to receive electrical power from the vehicle.

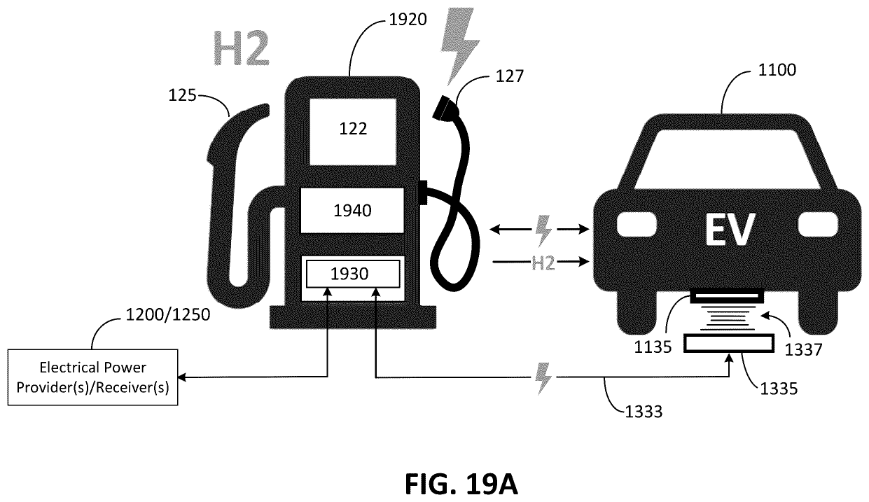

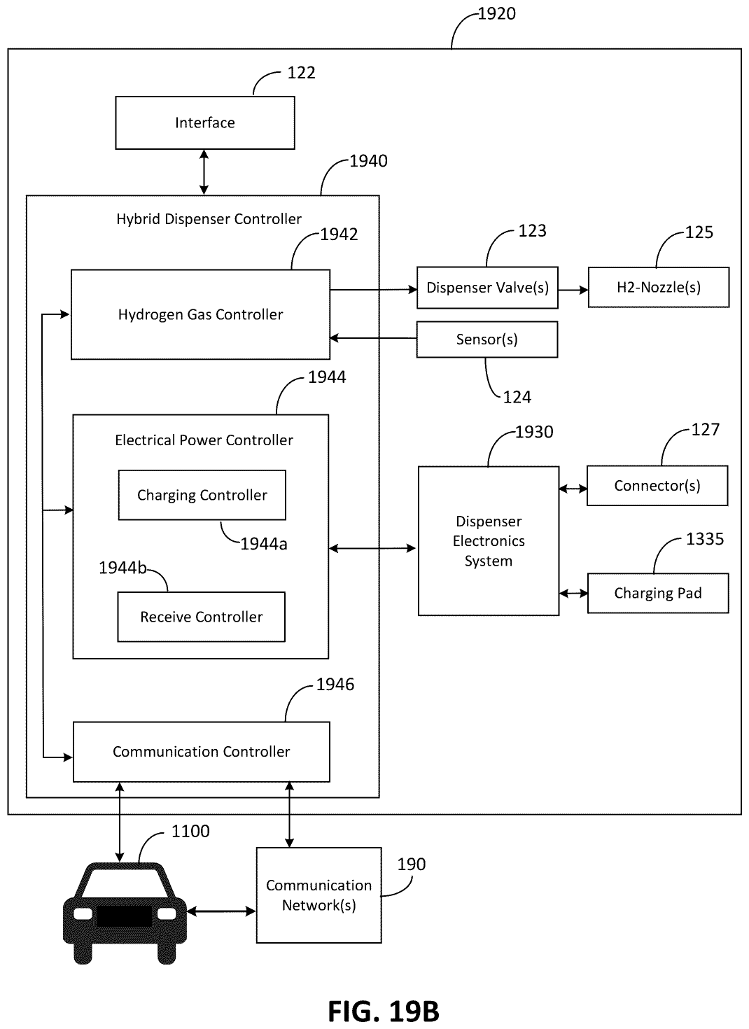

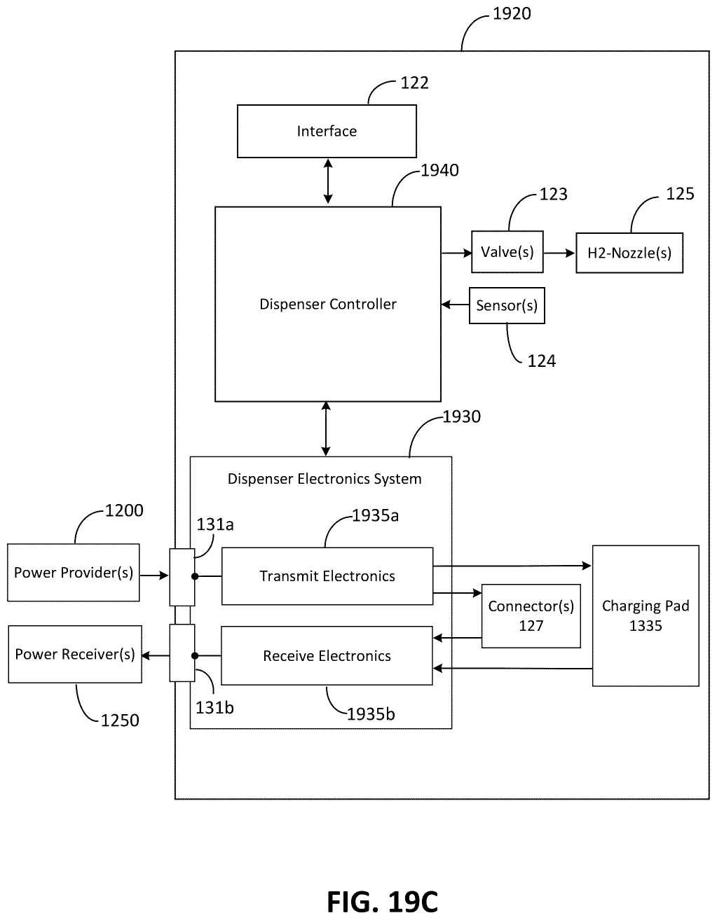

FIG. 19A-C illustrates exemplary hybrid dispensers 1920 configured to bi-directionally exchange electrical power both via wireless and plug-in connections with EVs, in accordance with some embodiments. As shown FIG. 19A, hybrid dispenser 1920 is configured to exchange electrical power bi-directionally with EV 1100 via one or more connectors 127 (e.g., as discussed above in connection with the hybrid dispensers illustrated in FIGS. 4A-4C, and 11) and wirelessly via bi-directional charging pad 1335 and charging unit 1135 (e.g., exemplary bi-directional wireless charging pad and charging unit illustrated in FIG. 18). As illustrated in FIG. 19B, hybrid dispenser controller 1940 may combine control functionality described in connection with dispenser controller 140 (e.g., as illustrated in FIG. 10C) and dispenser controller 1340 (e.g., as illustrated in FIG. 13B). For example, hybrid dispenser controller 1940 may include an electrical power controller 1944 comprising a charging controller 1944a configured to perform any of the control functionality described in connection with charging controller 144a illustrated in FIG. 10C and any of the control functionality described in connection with wireless charging controller 1344 illustrated in FIG. 13B to control dispenser electronics system 1930 to provide electrical power to one or more connector(s) 127 and/or to charging pad 1335 to perform plug-in charging, wireless charging or dual plug-in and wireless charging of the EV. Electrical power controller 1944 may comprise receive controller 1944b configured to perform any of the control functionality described in connection with receive controller 144b to control power electronics 1930 to receive electrical power from EVs via one or more connectors 127 and may be further configured to control power electronics 1930 to receive electrical power from charging pad 1335.

As illustrated in FIG. 19C, dispenser electronics system 1930 may combine electronic components/circuitry and functionality described in connection with dispenser electronics system 130 illustrated in FIG. 10D and described in connection with dispenser electronics system 1330 illustrated in FIG. 13C. For example, dispenser electronics system 1930 may include transmit electronics 1935a that includes any of the electronics described in connection with transmit electronics 135a illustrated in FIG. 10D to provide power to connector(s) 127 and any of the electronics described in connection with charging electronics 1035 illustrated in FIG. 13C to provide electrical power to charging pad 1335. As also shown in FIG. 19C, dispenser electronics system 1930 may include receive electronics 1935a that may include any of the electronics described in connection with receive electronics 135a illustrated in FIG. 10D to receive electrical power from EVs via connector(s) 127 and may further comprising electronics configured to receive electrical power from charging pad 1335.

In this way, dispenser controller 1940 can control the hybrid dispenser 1920 to perform a hydrogen fueling event, perform a wireless and/or plug-in EV charging event and/or utilize an EV as a mobile generator by receiving electrical power from the EV either wirelessly or via a plug-in connection to one or more connectors 127. Electrical power received from one or more EVs, whether received wirelessly or via plug-in connections, may be used to provide power to any one or combination of electrical power receivers in accordance with any of the techniques described herein. It should be appreciated that hybrid dispenser 1920 may be implemented with a bi-directional wireless charging system but no plug-in capabilities. Accordingly, the dispenser controller functionality and power electronics configured for plug-in charging and receiving electrical power from EVs via plug-in connections may be eliminated.

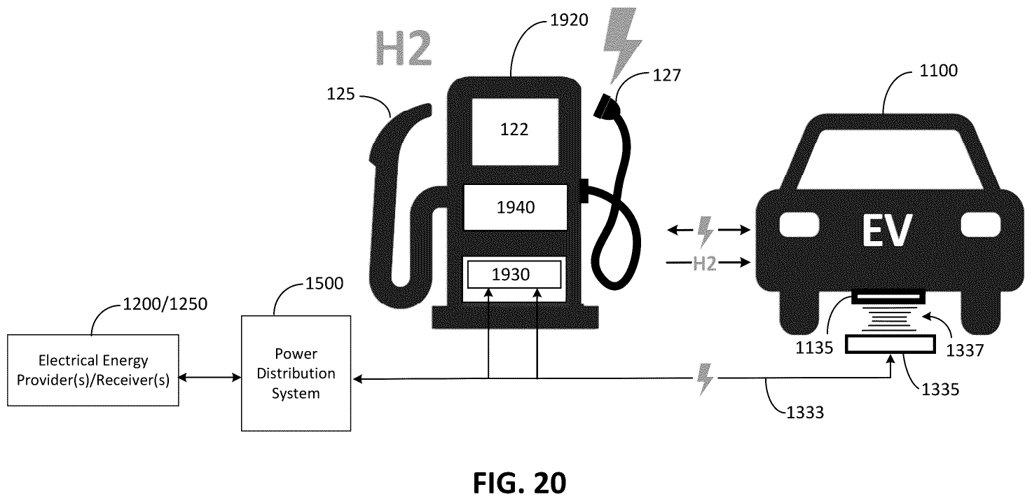

FIG. 20 illustrates a hybrid dispenser 1920 (e.g., a hybrid dispenser configured with bi-directional wireless and plug-in electrical power exchange capabilities) connected to a power distribution system 1500. In particular, hybrid dispenser 1920 may be used as any one or more of the hybrid dispensers 1220 illustrated in FIGS. 12B and 12C, but with an additional wireless channel for charging and receiving electrical power from EVs. Electrical power received via the wireless channel may then be distributed, stored or otherwise utilized in any of the ways discussed above in connection with FIGS. 12A-C. Additionally, hybrid dispenser 1920 illustrated in FIG. 20 coupled to power distribution system 1500 may be implemented with a bi-directional wireless charging system but no plug-in capabilities, as the aspects are not limited to having both wireless and plug-in capabilities.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain, using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods (e.g., processes or methods performed by any of the controllers described herein). In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The terms “approximately,” “about,” and “substantially” may be used to mean within ±20% of a target value in some embodiments, within ±10% of a target value in some embodiments, within ±5% of a target value in some embodiments, and yet within ±2% of a target value in some embodiments. The terms “approximately,” “about,” and “substantially” may include the target value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

What is claimed is:

1-34. (canceled)

35. A method of utilizing a vehicle as an electrical power generator, the method comprising:
dispensing hydrogen gas to a fuel cell system of the vehicle, wherein the fuel cell system converts the hydrogen gas to electrical power;
establishing at least one electrical connection to the vehicle;
receiving electrical power from the vehicle via the at least one electrical connection; and
providing at least some of the electrical power from the vehicle to one or more electrical power receivers.

36. The method of claim 35, wherein establishing the at least one electrical connection to the vehicle comprises establishing at least one electrical connection between the vehicle and a hybrid dispenser configured to perform the dispensing of the hydrogen gas and the receiving of the electrical power.

37. The method of claim 36, wherein establishing the at least one electrical connection comprises establishing a first physical connection between the hybrid dispenser and the vehicle, and wherein receiving electrical power from the vehicle includes receiving electrical power via the physical connection.

38. The method of claim 37, wherein the first physical connection is established by connecting an electrical connector on an end of an electrical cable connected to the hybrid dispenser to a reciprocal connector of the vehicle.

39. The method of claim 37, wherein the first physical connection is established by connecting an electrical cable to a dispenser connector provided on the hybrid dispenser, the electrical cable having a first connector configured to connect to the dispenser connector and a second connector configured to connect to a vehicle connector on the vehicle.

40. The method of claim 36, wherein establishing the at least one electrical connection comprises establishing a wireless connection between the hybrid dispenser and the vehicle.

41. The method of claim 40, wherein the wireless connection is established via an electromagnetic coupling between a first wireless charging component controlled by the hybrid dispenser and a second wireless charging component electrically provided on the vehicle.

42. The method of claim 41, wherein receiving electrical power from the vehicle comprises receiving electrical current induced in the first wireless charging component by an electromagnetic field produced by the second wireless charging component using electrical power from the vehicle.

43. The method of claim 37, wherein establishing the at least one electrical connection further comprises establishing a wireless connection between the hybrid dispenser and the vehicle, and wherein receiving electrical power from the vehicle comprises receiving electrical power via the first physical connection and receiving electrical power via the wireless connection.

44. The method of claim 36, wherein providing electrical power to one or more electrical power receivers includes providing at least some electrical power received from the vehicle to operate at least one component of the hybrid dispenser.

45. The method of claim 36, wherein providing electrical power to one or more electrical power receivers includes providing at least some electrical power received from the vehicle to at least one other dispenser.

46. The method of claim 45, wherein the at least one other dispenser comprises one or more of a hydrogen gas dispenser, a charging station and/or another hybrid dispenser.

47. The method of claim 36, wherein providing electrical power to one or more electrical power receivers includes providing at least some electrical power received from the vehicle to electrical infrastructure to which the hybrid dispenser is coupled.

48. The method of claim 47, wherein the electrical infrastructure includes at least one electrical power network from which the hybrid dispenser is configured to receive electrical power during a first operating mode.

49. The method of claim 48, wherein the at least one electrical power network includes a mains electrical network providing single-phase AC power, and wherein providing electrical power to one or more electrical power receivers includes providing at least some electrical power received from the battery of the vehicle to power one or more electronic components connected to the mains electrical network.

50. The method of claim 48, wherein the at least one electrical power network includes a utility grid providing three-phase AC power, and wherein providing electrical power comprises providing at least some of the electrical power received from the vehicle to the utility grid.

51. The method of claim 47, wherein the electrical infrastructure includes a power distribution system coupled to a plurality of electrical power providers and a plurality of electrical power receivers, and wherein providing electrical power comprises providing at least some of the electrical power received from the vehicle to the power distribution system to operate one or more of the plurality of electrical power receivers coupled to the power distribution system.

52. The method of claim 36, wherein the hybrid dispenser comprises a power electronics system configurable to provide electrical power from one or more electrical power providers to electric vehicles in a first operating mode and to receive electrical power from electric vehicles in a second operating mode, the method further comprising:
configuring the power electronics to operate in the second operating mode in response to a change in operation of at least one of the one or more electrical power providers.

53. The method of claim 52, wherein the change in operation includes a disruption in electrical power provided by the at least one electrical power provider.

54. The method of claim 52, wherein the change in operation includes a change in a usage cost of power provided from the at least one electrical power provider.

55. The method of claim 52, wherein the change in operation includes a change in demand of electrical power provided from the at least one electrical power provider.

56. The method of claim 35, wherein dispensing hydrogen gas is performed by a transportable hydrogen gas supply and wherein establishing the at least one electrical connection to the vehicle comprises establishing at least one electrical connection between the vehicle and at least one of the one or more electrical power receivers.

57-81. (canceled)
